(19) United States
(12) Patent Application Publication
(10) Pub. No.: US 2007/0288382 A1
(43) Pub. Date: Dec. 13, 2007

(54) Check21 image based document and processing system

(75) Inventors: Sethuraman Narayanan, Alpharetta, GA (US); Kathleen Narayanan, Alpharetta, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(73) Assignee: Avalon International, Inc.

(21) Appl. No.: 11/799,888

(22) Filed: May 2, 2007

Related U.S. Application Data
(60) Provisional application No. 60/797,605, filed on May 3, 2006.

(51) Int. Cl. G06Q 40/00; G06F 17/30

(52) U.S. Cl. 705/45; 382/137; 707/104.1

(57) ABSTRACT

A Check21 Act image based document and processing system, comprising a modular hardware and software image-based financial processing system with independent software modules supporting specific hardware and or processing applications; thereby, simplifying the process for the removal or addition of support for new computer platforms, components, features, peripherals, applications and/or interoperating with legacy hardware and software systems.

### PRIORITY CLAIM TO RELATED US APPLICATIONS

To the full extent permitted by law, the present United States Non-Provisional patent application claims priority to and the benefit of United States Provisional patent application entitled “Check21 Image Based Document and Processing System” filed on May 3, 2006, having assigned Ser. No. 60/797,605.

### TECHNICAL FIELD

The present invention relates generally to methods and systems for imaging and processing documents, and more particularly to a Check21 image based document and processing system for electronic imaging and processing of financial documents, such as checks and related documents within a distributed architecture system.

### BACKGROUND OF THE INVENTION

In a conventional, paper-based check collection system, most paper checks are physically delivered by the writer of the particular check (i.e., the payor) to the person or entity to whom the check is made out (i.e., the payee). The check is deposited in the payee's financial institution, which is referred to as the bank of first deposit or the depository bank. The check is physically delivered by the depository bank to the bank on which the check is drawn (i.e., the paying bank), and ultimately back to the payor. Generally, checks delivered to a paying bank are accompanied by a cash-letter, which lists all of the checks being delivered and information about each check, including the amount of the check. Delivering the paper check from the depository bank to the paying bank can involve numerous check sorting processes and multiple intermediary collecting banks as the check moves through the collection process. If the check for some reason is not honored by the paying bank, e.g., because the payor has insufficient funds, then the check travels back to the depository bank and the payee.

In particular, within this check collection system, billions of paper checks are physically shuffled back and forth among various entities, entailing significant costs and time delays. Moreover, due to banking regulations, the collection process must take place within strict time schedules. For example, the paying bank has only one to one and a half days from the time a check is presented to decide whether to return the check and recover its payment before the check is final. Also, the payee may lose interest for each day's delay in the collection process. Of course, such collection processes are vulnerable to physical phenomenon, such as transportation delays caused by severe weather, natural disasters, strikes, and terrorism.

Accordingly, electronic check presentment (ECP) is being used to supplement the traditional paper check collection process to alleviate some of the delays inherent in a paper based process. Currently, in ECP, the depository bank or a collecting bank electronically reads from each paper check the account number, routing transit number (RTN), dollar amount and check number, which are printed on the check in a magnetic ink character recognition (MICR) line (this information is referred to as the “MICR information”), and possibly other information as well. This information is used to create a separate electronic record, referred to as an electronic check or cash-letter, which is sent to the paying bank. The original paper checks are often sent at a later time.

For example, a depository bank may electronically send an electronic cash letter for checks deposited on Monday, which will reach the paying bank by Monday evening. The paper checks usually arrive at the paying bank by the next day (Tuesday), in time for the returns process. After the paying bank receives the paper checks and reads the MICR data from them, it reconciles the paper checks with the electronic cash-letter received earlier to determine missing or free items. The items to be returned, e.g., for lack of funds on deposit, are pulled and returned to the depository bank. However, one disadvantage of this process is that it is not entirely paperless; that is, it still requires the movement of paper checks.

To reduce the movement of paper checks, check image exchange, also referred to as check truncation, has been generally proposed as an alternative. To this end, on Jun. 6, 2003, the United States House of Representatives passed “The Check Clearing for the 21st Century Act.” Following the passage of the House Bill, the United States Senate enacted on Jun. 27, 2003, S. 1334, “The Check Truncation Act of 2003.” Both of these legislations are referred to informally as “Check21 Act”. These laws are aimed to improve the check and remittance payment systems by allowing banks, financial institutions, and remittance payment processors (e.g., utility and insurance companies) to exchange checks electronically instead of via the current paper-based exchange. President George W. Bush signed the Check21 Act into law on Oct. 28, 2003, and when the law went into effect on Oct. 28, 2004, a printed image of a check or remittance processing stub was given the same legal standing as its original paper counterpart.

Since Oct. 28, 2004 and the signing of the Check21 Act, banks, financial institutions, and remittance payment processors have been moving away from paper-based financial document processing environments and toward image-based processing environments, wherein images of checks and remittance processing stubs are used to perform data entry, correction and balancing operations. The adoption of such image-based document processing has yielded improvements in processing throughput and reduced labor costs.

The Check21 Act allows banks to voluntarily exchange electronic images over networks, legally acknowledging an electronic financial document as the legal equivalent of a paper financial document. In this check truncation environment, only images of the checks are electronically transmitted between financial institutions, and the paper documents are either held or destroyed by the bank of first deposit. Financial institutions desiring to continue processing paper can receive a substitute check, i.e., a paper reproduction created from an electronic image of the original check, for clearing and settlement and ultimate return to the accountholder. This substitute check has the legal equivalence of the original paper check.

Various financial institutions are transitioning traditional paper check collection and return processes into electronic processes. Such efforts are being undertaken to reduce the costs, time delays, and other problems associated with the processing of the over 40 billion paper checks collected per year in the United States. For example, the Federal Reserve, the central bank of the United States, has adopted Accredited Standards Committee (ASC) financial image interchange standard entitled “Specifications for Electronic Exchange of Check and Image Data, DSTU X9.37-200×,” hereinafter referred to as “the X9.37 standard,” to support the exchange of check/document imagery between financial institutions.

Generally, imaging involves optically scanning documents to produce electronic images that are processed electronically and stored on high capacity storage media (such as magnetic disc drives and/or optical memory) for later retrieval and display. More specifically, in retail merchant cashier and check-out applications, small and relatively inexpensive bank check readers which capture MICR (magnetic ink character recognition) data and digital image files are commonly used for processing checks. The MICR code line is read by a MICR reader, and the digital image files are created by an optical scanner as the paper check passes through the device. These devices, typically peripherals to a personal computer, are often used in a process known as check conversion and truncation. In check conversion and truncation, the merchant uses the check reader to create a MICR and digital image file, and converts the check to a digital image file in accordance with X9.37 standard.

With the passage of Check21 Act, banks and other financial institutions are implementing Check21 image-based financial processing systems. Vendors of such Check21 image-based financial processing systems are often required to interoperate with various legacy subsystems currently in use by such banks and other financial institutions, such as MICR reader, optical scanner, personal computers, data storage devices and the like.

Prior art image-based financial processing systems are unable to interoperate with various legacy subsystems, as well as cope with the growing complexity and requirements of new computer platforms, components, features, peripherals, applications and/or legacy hardware and software. In addition, the prior art code for such systems consists of a lengthy series of undivided code unable to perform discrete functions or tasks, or any subset of functions specific to a particular hardware device. If a programmer wishes to amend the prior art code to add or delete an existing feature or function, or to add or delete hardware, the programmer must search the entire code line-by-line to locate the appropriate code section or sections within the prior art code, an inefficient and time consuming task. More specifically, complete re-writing of the prior art code is required for compatibility and/or interoperability with legacy hardware and software, as well as integrating new platforms, components, features, peripherals, and/or applications or other future evolutions.

Therefore, it is readily apparent that there would be a recognized benefit from a new image-based financial processing system that is modular in design, thereby allowing for a simplified process for the removal or addition of support for new computer platforms, components, features, peripherals, applications and/or legacy hardware and software.

### BRIEF SUMMARY OF THE INVENTION

Briefly described, in the preferred embodiment, the present invention overcomes the above-mentioned disadvantages and meets the recognized need for such a process by providing a Check21 image based document and processing system, comprising a modular hardware and software image-based financial processing system with independent software modules supporting specific hardware and/or applications, thereby simplifying the process for the removal or addition of support for new computer platforms, components, features, peripherals, applications and/or interoperating with legacy hardware and software systems.

According to its major aspects and broadly stated, the present invention in its preferred embodiment is a Check21 image based document and processing system, comprising modules for central capture, distributed capture, remittance capture, image exchange, incoming exchange, outgoing exchange and repository (known as “Data Warehouse”).

More specifically, the present invention is a Check21 image based document capture and processing system that is modular in design, comprising isolated code sections that perform specific functions and/or further consists of subroutines that support specific hardware devices. A programmer may amend individual code sections or subroutines without having to search the entire code line-by-line for applicable code. Thus, because the code is modular, it allows a programmer to quickly activate, remove or add support for new computer platforms, components, features, peripherals, devices, applications and/or legacy hardware and software by accessing, editing, adding and/or deleting the specific code section or subroutine that pertains to a particular device, technology, feature and/or function as well as enabling down scaling of the code for specific applications and systems.

Accordingly, a feature and advantage of the present invention is its modular and scalable design allowing any of the Check21 Act modules, or their sub-modules or parameters within each sub-module, to be selectively activated or deactivated depending on the needs of the financial institute or its legacy equipment, thus eliminating the need for costly integration of separate applications.

Another feature and advantage of the present invention is its ability to provide a comprehensive integrated capture solution which includes an array of check processing features, functionality and interoperability with third party capture devices.

Another feature and advantage of the present invention is its ability to provide support for Check21 Act modularity and scalability solutions, thereby facilitating the removal or addition of support for specific Check21 Act functionality.

Another feature and advantage of the present invention is its ability to evolve with future architectures.

Another feature and advantage of the present invention is its ability to provide an check processing system capable of processing documents utilizing full image scanning whether central or remote.

Another feature and advantage of the present invention is its ability to provide a check processing system, wherein approval for payment of documents, such as checks, is obtained through the ACH system.

Another feature and advantage of the present invention is its ability to provide a check processing system where information obtained from the check is stored in an image file.

Another feature and advantage of the present invention is its ability to provide an check processing system whereby the full image of the scanned check can be communicated to a central processing system.

Still another feature and advantage of the present invention is its ability to provide a modular solution, thereby allowing customization and specialization of the code for specific financial systems.

Still another feature and advantage of the present invention is its ability to provide a single module installed to enhance a third party vendor's “installed” check processing system.

Yet another feature and advantage of the present invention is its ability to exchange information with other financial institutions regardless of platform or processing platform architecture.

Yet another feature and advantage of the present invention is its ability to be modular, scalable and configurable for applications for the smallest (community bank) to the largest tier one, multi-site financial institutions.

Yet another feature and advantage of the present invention is its ability to reduce physical paper check transportation costs.

Yet another feature and advantage of the present invention is its ability to provide sophisticated image capture and recognition features, thereby reducing the need for data entry to correct image and data errors.

Yet another feature and advantage of the present invention is its ability to provide image file capture using multiple capture devices.

Yet another feature and advantage of the present invention is its ability to provide technology specific modules and to define protocol for inter-module communication.

Yet another feature and advantage of the present invention is its ability to provide end-to-end payment processing, seamless design between modules, capture anywhere/process anywhere, smart clients interface, MICROSOFT .NET Web Server, remote and offshore data entry, legacy systems interface, and centralized configuration and administration features.

Yet another feature and advantage of the present invention is its ability to provide a reduction in expenses on a per check transaction basis, and a reduction in courier and overall transportation costs, to enable check truncation at the source, and conversion of non-image accounts to image accounts, to eliminate item capture pass with incoming image clearings, to eliminate physical encoding of outbound cash-letters, and to improve fraud detection and customer service, imaging technology, and paperless statements.

Yet another feature and advantage of the present invention is its ability to provide improved means and methods for employing electronic imaging in a complete Check21 document processing system based on the Check21 Act 2004.

Yet another feature and advantage of the present invention is its ability to provide such improved means and methods in a manner which significantly improves document processing productivity by offering a complete integrated modular system that can both stand alone or totally interface in part or whole with existing check processing systems.

Yet another feature and advantage of the present invention is its ability to provide a document processing system employing Check21 imaging and imaging processing organized for operation in a manner which significantly reduces labor costs.

Yet another feature and advantage of the present invention is its ability to provide improvements in system architecture, system management, transaction error correction and reconciliation, image quality and usability handling and resolution, duplicate check recognition, and automated returned items processing and management.

The main object of the invention is to create a set of logical processing steps for a path or a “bridge” to the inventions new technological Check21 processing system without having to eliminate or throw away current check processing systems, by investing and building Check21 processes on old technology and systems, while also being able to process a fully functional end to end Check21 system.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system environment for embodiments of the present invention.

FIG. 2 is a block diagram of a communications system implemented by the system in FIG. 1;

FIG. 3 is a module diagram of a process, according to the preferred embodiment of the present invention, implemented by the system in FIG. 2;

FIG. 4 is a module diagram of a process, according to the preferred embodiment of the present invention, implemented by the system in FIG. 2;

FIG. 5 is a module diagram of a process, according to the preferred embodiment of the present invention, implemented by the system in FIG. 2;

FIG. 6 is a module diagram of a process, according to the preferred embodiment of the present invention, implemented by the system in FIG. 2;

FIG. 7 is a module diagram of a process, according to the preferred embodiment of the present invention, implemented by the system in FIG. 2;

FIG. 8 is a module diagram of a process, according to the preferred embodiment of the present invention, implemented by the system in FIG. 2;

FIG. 9 is a module diagram of a process, according to the preferred embodiment of the present invention, implemented by the system in FIG. 2;

FIG. 10 is a module diagram of a process, according to the preferred embodiment of the present invention, implemented by the system in FIG. 2; and

FIG. 11 is a module diagram of a process, according to the preferred embodiment of the present invention, implemented by the system in FIG. 2.

### DETAILED DESCRIPTION OF THE PREFERRED AND ALTERNATIVE EMBODIMENTS

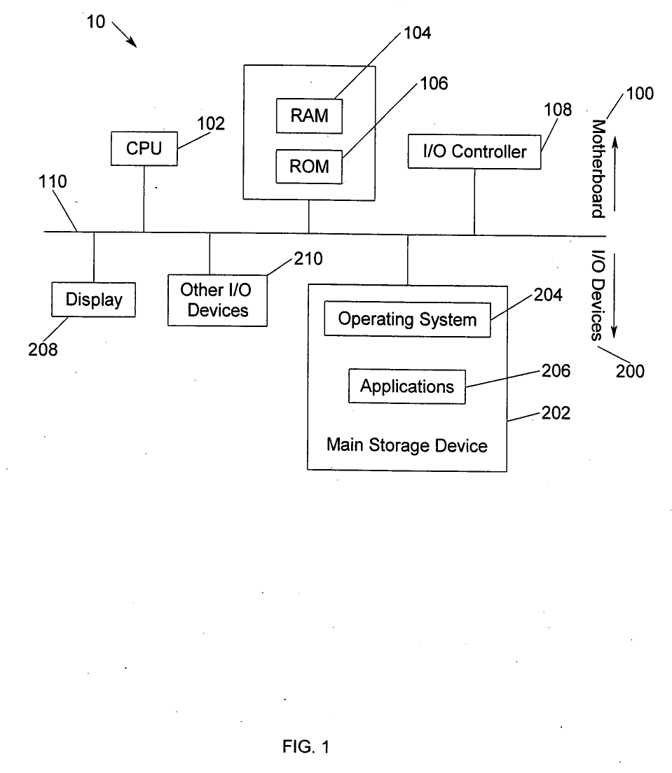

In describing the preferred and alternate embodiments of the present invention, as illustrated in FIGS. 1-11, specific terminology is employed for the sake of clarity. The invention, however, is not intended to be limited to the specific terminology so selected, and it is to be understood that each specific element includes all technical equivalents that operate in a similar manner to accomplish similar functions.

As will be appreciated by one of skill in the art, the present invention may be embodied as a method, process, data processing system, or computer program product. Accordingly, the present invention may take the form of an entirely hardware embodiment, entirely software embodiment or an embodiment combining software and hardware aspects. Furthermore, the present invention may take the form of a computer program product on a computer-readable storage medium having computer-readable program code means embodied in the medium. Any suitable computer readable medium may be utilized, such as hard disks, ROM, RAM, CD-ROMs, optical storage devices, or magnetic storage devices.

The present invention is described below with reference to flowchart illustrations of methods, modular representations of processes, apparatus (systems) and computer program products according to embodiments of the invention. It will be understood that each block or step of the flowchart or module illustrations, and combinations of blocks or steps in the flowchart or module illustrations, can be implemented by computer program instructions. These computer program instructions may be loaded onto a general purpose computer, special purpose computer, or other programmable data processing apparatus to produce a machine, such that the instructions which execute on the computer or other programmable data processing apparatus create devices and/or means for implementing the functions specified in the flowchart block, module block, or blocks/step or steps.

These computer program instructions may also be stored in a computer-usable memory that can direct a computer or other programmable data processing apparatus to function in a particular manner, such that the instructions stored in the computer-useable memory produce an article of manufacture including instruction means which implement the function specified in the flowchart block, module block, or blocks/step or steps. The computer program instructions may also be loaded onto a computer or other programmable data processing apparatus to cause a series of operational steps or modules to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart or process illustrations support combinations of means for performing the specified functions, combinations of steps for performing the specified functions and program instruction means for performing the specified functions. It will also be understood that each block or step of the flowchart or module illustrations, and combinations of blocks or steps in the flowchart or module illustrations, can be implemented by special purpose hardware-based computer systems which perform the specified functions or steps, or combinations of special purpose hardware and computer instructions.

Computer programs for implementing the present invention may be written in various programs, including, but not limited to object-oriented programming languages, such as conventional C calling. However, it is understood that other source and/or object oriented programming languages, and other conventional programming languages may be utilized without departing from the spirit and intent of the present invention.

Referring now to FIG. 1-11, the present invention in its preferred embodiment is a Check21 image based document and processing system, comprising a modular hardware and software image-based financial processing system with independent software modules for central capture, distributed capture (comprised of merchant capture, front teller capture, back counter branch capture, remote sorter capture, and ATM capture), remittance capture, image exchange, incoming exchange, outgoing exchange and data warehouse for supporting specific hardware and/or software applications for implementing Check21 image processes, wherein the process for the removal or addition of support for new computer platforms, components, features, peripherals, devices, applications and/or legacy hardware and/or software systems is simplified and made more efficient.

Referring now to FIG. 1, there is illustrated a block diagram of a computer system 10 that provides a suitable environment for implementing embodiments of the present invention. The computer architecture shown in FIG. 1 is divided into two parts—motherboard 100 and input/output (I/O) devices 200. Motherboard 100 includes subsystems such as central processing unit (CPU) 102, random access memory (RAM) 104, input/output (I/O) controller 108, and read-only memory (ROM) 106, also known as firmware, which are interconnected by bus 110.

A basic input output system (BIOS) containing the basic routines that help to transfer information between elements within the subsystems of the computer is stored in ROM 106 or operably disposed in RAM 104. Computer system 10 further includes I/O devices 200, such as main storage device 202 for storing an operating system 204 and application program(s) 206, and display 208 for visual output. Main storage device 202 is connected to CPU 102 through a main storage controller (represented as 108) connected to bus 110. Network adapter 210 allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems may be connected in a similar manner, including but not limited to, devices such as microphone, speakers, sound card, keyboard, pointing device (e.g., a mouse), floppy disk, CD-ROM player, printer, modem, MICR reader, and/or optical scanner, each connected via I/O adapter.

Moreover, it is not necessary for all of the devices shown in FIG. 1 to be present to practice the present invention, as discussed below. Furthermore, the devices and subsystems may be interconnected in different ways from that shown in FIG. 1, or may be based on optical or biological processors or gate arrays or some combination of these elements that is capable of responding to and executing instructions. The operation of a computer system such as that shown in FIG. 1 is readily known in the art and is not discussed in further detail in this application, so as not to overcomplicate the present discussion.

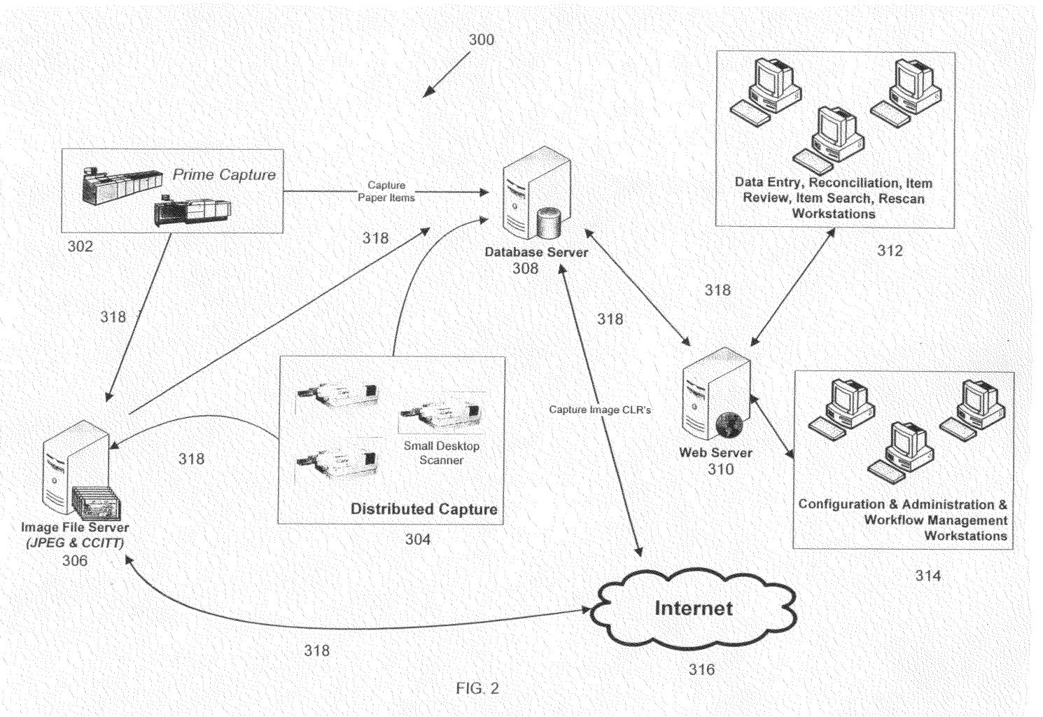

Referring now to FIG. 2, there is illustrated a diagram depicting an exemplary Check21 image based document and processing system 300 in which concepts consistent with the present invention may be implemented. Examples of each element within processing system 300 of FIG. 2 are broadly described above with respect to FIG. 1. Before describing the elements within processing system 300 of FIG. 2 it is helpful to understand the different medium that will be processed by system 300. The medium is typically a check. It is contemplated, however, that other types of items could be processed, such as Deposit Tickets, Remittance Stubs, G/L Tickets, Batch Tickets, Block Tickets, End Of Job Tickets, or any possible documents or negotiable instrument a financial organization may want to process (Items). Processing system 300 comprises paper checks, electronic images of the checks, data files of checks, and an image replacement document (IRD), which is an image of a check reprinted on paper and used when the receiving endpoint is only capable of processing checks as paper items. As a result, incoming checks, pay stubs and the like that are received into the processing system 300 of FIG. 2 are either in the form of paper items or electronic image files, and outgoing items are paper checks (Items), IRDs or electronic files containing the check images and their data. Moreover, processing system 300 is compliant with the accredited standards committee (ASC) for financial services proposed financial image interchange standard (Specifications for Electronic Exchange of Check and Image Data, DSTU X9.37-2003, X9.100, and X9.180, hereinafter referred to as “the X9.37 standard,” to support the exchange of check/document imagery between financial institutions. By “financial institution,” it is meant to include savings and loans, investment houses, and all other types of financial institutions whether private, public, or government based. The U.S. Federal Reserve has adopted the X9.37 standard, which is published by the American National Standards Institute, and which is hereby incorporated herein by reference.

In particular, in FIG. 2 there are three classes of hardware elements, capture devices and/or systems, servers and workstations, all having attributes similar to computer system 10 of FIG. 1, further illustrating one possible implementation of that system. The number and size of each hardware element is predicated on the number of financial institution locations, the overall volume of Items and number of Items processed in a particular window of time. The preferred Check21 image based document and processing system hardware is scalable to fulfill the processing requirements of the smallest to the largest financial institutions. Processing system 300 preferably includes one or more capture devices 301, and one or more servers 303, one or more workstations 305, and/or a network 307, which could be, for example, local area network or the Internet.

### Capture Devices 301

Capture devices 301 include prime capture 302 and distributed capture 304. Prime capture 302 is the process by which most paper checks enter check processing in financial institutions. Prime capture 302 includes high, medium and low speed check image and MICR readers and sorters. Prime capture 302 systems are manufactured by various vendors, such as UNISYS, IBM, NCR, BANCTEC and the like. The primary functionality of prime capture 302 reader/sorters includes feeding batches of checks, reading the MICR (Magnetic Ink Character Recognition) data from the bottom of the check, printing (endorsing) identifying information on the check, capturing images of both sides of the paper check and sorting the paper item to a designated pocket endpoint destination predetermined from the MICR data read earlier. In addition, prime capture 302 systems may include, but are not limited to, additional functionality such as the ability to open payment mailings and capture the paper checks in said mailings during prime capture. Processing system 300 preferably executes modular application software instructions and interface drivers to control performance and operation of prime capture 302 reader/sorter and the flow of electronic files created during prime capture 302.

Prime capture 302 preferably is a central capture operation as in the main processing location of the financial institution; however, prime capture 302 readers/sorters may be located at remote processing sites and linked to the central capture site in accordance with the invention. For example, a remote reader/sorter may capture all the checks from a branch office or a number of bank branches in a remote area.

Distributed capture 304 preferably is the process by which smaller volumes of checks enter check processing, typically in remote locations such as corporations, branch banks, retail operations, payment walk-in locations and the like. Distributed capture 304 includes medium and low speed check image and MICR readers and sorters. Distributed capture 304 systems are manufactured by various vendors and include the family of small and table top scanners that are used to capture a smaller volume of checks. The primary functionality of distributed capture 304 reader/sorters includes feeding checks, reading the MICR (Magnetic Ink Character Recognition) data from the bottom of the check, printing (endorsing) identifying information on the check, capturing images of both sides of the paper check, and optionally sorting the paper item. Typically, branch back office capture volume is greater than branch front teller or corporate capture volumes, wherein such check volumes designate the scanner speed required for capture devices 301.

Processing system 300 preferably executes modular application software instructions and interface drivers to control performance and operation of prime capture 302 and/or distributed capture 304 reader/sorter, the flow of electronic files created during prime capture 302, and/or distributed capture 304 to control the physical sorter operations.

Processing system 300 preferably evaluates the image quality for each Item and if the image quality is unsatisfactory based on the X9.37 standard, processing system 300 preferably instructs prime capture 302 or distributed capture 304 to rescan such check to capture an image that complies with image quality and/or usability requirements of the X9.37 standard.

Servers 303

Servers 303 preferably include image file server 306, data server 308, and web server 310. Servers 303, although depicted as a single computer system, may be implemented as a network of computer processors. For example, the servers 303 may include one or more general-purpose computers (e.g., personal computers), one or more special purpose computers (e.g., devices specifically programmed to communicate with each other) or other equipment, or some combination of these elements that is capable of responding to and executing instructions. Image file server 306 is a scalable industry standard server and preferably is the temporary storage for the image files of images captured from the paper items on prime capture 302 and distributed capture 304. Storage capacity and processing speed of image server 306 is governed by image file volume, processing window duration and/or end-user fault tolerance, and redundancy requirements of processing system 300. Image file server 306 is capable of communicating with various prime capture 302 and distributed capture 304 reader/sorter devices and to collect image files from each capture device 301 within processing system 200 over communication link 318. Communication link 318 may be any link used for data, voice, or video communications that is known in the art, such as a telephone line, Ethernet, LAN, Internet, radio, microwave and the like. Distributed capture 304 and prime capture 302 reader/sorter devices are coupled to image file server 306 via communication link 318. Image file server 306 is responsible for providing any additional processing required of the images or image files transmitted from prime capture 302 and distributed capture 304.

Processing system 300 preferably executes modular application software instructions, services and interface drivers to interface with image file server 306 for accessing and acquiring the image files for a complete array of check processing, such as amount entry (for CAR/LAR failures), item correction, reconciliation (for image balancing), image character recognition (ICR) (for image field data capture), Item search, image quality analysis (IQA) (for image quality and usability testing), Item review, rescan (for rescanning images of image failure items) and image cash letter (ICL) (for creating the X9.37 files of cash letters with images) and the like.

Data server 308 is a scalable industry standard server and preferably is the permanent or semi-permanent storage for the image files captured from the paper items on prime capture 302 and distributed capture 304. Storage capacity and processing speed of data server 208 is governed by image file volume, processing window duration and/or end-user fault tolerance and redundancy requirements of processing system 300. Data server 308 may additionally include a secondary storage element for storage of data, and information. Data server 308 is capable of isolated processing as a stand alone processing system or interfacing with other elements of processing system 300, such as prime capture 302 and distributed capture 304 reader/sorter devices, image file server 306, web server 310 (below) to collect image files from each capture device 301 and image file server 306 in processing system 300.

Distributed capture 304 and prime capture 302 reader/sorter devices are coupled to database server 308 via a communication link 318. Additionally, database server 308 is capable of communicating with image file server 306 via network connection 307 or communication link 318. Moreover, data server 308 preferably executes modular application software instructions, services and interface drivers to interface with image file server 306 for accessing and acquiring the image files from prime capture 302 and distributed capture 304 reader/sorter devices, image file server 306 for processing and/or executing modular applications and/or modules including but not limited to central capture, distribution capture, and remittance capture, image exchange and/or Check21 data warehouse information (Modules) (shown below) according to a preferred embodiment of processing system 200. Processing system 300 preferably is modular in design, enabling data server 308 to execute one or more such Modules, allowing scalability and interoperability with existing legacy subsystems. Data server 308 preferably employs a database software application, such as SQL: however, other commercially available database software applications are feasible.

Web server 210 is a scalable industry standard server and preferably is a .NET web server. Storage capacity and processing speed of web server 210 is governed by image file volume, processing window duration and/or end-user fault tolerance and redundancy requirements of processing system 200. Web server 310 is capable of communicating with data server 308, enabling data server 308 to execute modular application software instructions and services requested from workstations (described below). Moreover, web server 310 is capable of communicating with all workstations via communication link 318 (described below), enabling data entry, reconciliation, configuration, administration and workflow management operations of central capture, distribution capture, and remittance capture, image exchange and/or Check21 data warehouse information of processing system 300. Database server 308 is coupled to web server 310 via a communication link 318. Additionally, web server 310 is capable of communicating with web server 310 via network connection 307.

### Workstations 305

Workstations 305 preferably are personal computer (PC) based workstations configured with Ethernet connections and adequate CPU, memory, hard drive and screen size to support image interpretation and production data entry of processing system 300. Workstations 305 may include one or more general-purpose computers (e.g., personal computers), one or more special purpose computers (e.g., devices specifically programmed to communicate with each other), or some combination of these elements that is capable of responding to and executing instruction. Workstations 305 may also include a number of additional external or internal devices, such as, without limitation, a mouse, a CD-ROM, a keyboard, a display, a storage device and other attributes similar to computer system 10 of FIG. 1. Workstations 305 may additionally include a secondary storage element for storage of data and information. Workstations 305 include workstation 312 and workstation 314.

Workstations 305 enable an operator of processing system 300 to perform workstation applications, wherein such applications include data entry (amount entry and Item correction), reconciliation (image balancing of transactions, batches, blocks, jobs, or runs of work), Item review, Item search (data warehouse, reconciliation, ATM balancing or remittance) and Item rescan and the like from either workstation 312 and workstation 314. Moreover, workstations 305 enable an operator of processing system 300 to perform system configuration and administration, which are system tools that allow varying features and functions to be designed and/or customized for functions such as workflow management and other processes for specialized application(s) or processes. Workflow management is a supervisory tool application running on workstations 305 which tracks Items, volume and dollar value of each Item or group of Items (whether paper or images), work in process, backlogged work, the number on operators using processing system 300, availability and identifying work that can be reassigned within processing system 300 and the like. Each application is operational on any workstations 305, as allowed under the parameters set in system configuration processing system 300.

Item review allows an operator of workstations 305 to analyze the images of Items that failed the parameters for Check21 image quality or usability, whether captured by paper or sent in an X9.37 image file. The operator of workstations 305 or processing system 300 can determine whether to accept or reject the X9.37 image file. If rejected, the Item preferably is directed to an Item rescan station, wherein the Item is rescanned using capture devices 301, such as a table top check image scanner, to capture a new replacement X9.37 image file of the Item. In the case of an incoming Check21 X9.37 image file, Item review similarity allows an operator of workstations 305 or processing system 300 to determine whether to accept or reject the X9.37 image file for processing. If rejected, the sending institution will be required to capture a new replacement X9.37 image file and resend X9.37 image file for Item review.

Item search preferably allows an operator of workstations 305 to search servers 303, to retrieve X9.37 image files and to locate all Item information archived in processing system 300. For example, Item search is utilized when errors have been detected in recording particular check amounts during reconciliation and balancing. As a second example, Item search is utilized to verify ATM balancing and remittance. Processing system 300 is capable of interfacing with an external database which contains the customer keying information of the amount keyed in at the ATM upon customer deposit. Processing system 300 may accept the ATM envelope deposit and update the customers account if the ATM deposit contents X9.37 image file electronically read during image capture from the ATM matches the amount keyed in at the ATM. ATM balancing includes receiving ATM deposits files from the ATM transaction system, processing and recognizing ATM envelopes as credits, performing intelligent character recognition (ICR) on the envelopes, performing deposit research, review and balancing. Still further, image ATM's operate under remote capture (branch) as another branch back counter capture device.

Network 307

Network 307 consists of the physical communications and network hardware interfacing and connecting processing system 300 for transfer of both incoming and outgoing electronic files. Examples of a network 307 include the Internet 316, the World Wide Web, WANs, LANs, analog or digital wired and wireless telephone networks (e.g. PSTN, ISDN, or XDSL), radio, cable, satellite, and/or any other delivery mechanism for carrying and/or transmitting data or other information over private or financial networks designated commercially for Check21 application. The communications link 318 may include, for example, a wired, wireless, cable, optical or satellite communication system or other pathway, wherein electronic files will be exchanged according the Check21 Act, including incoming and outgoing X9.37 and image replacement document (IRD) files, returned items files and rescanned item file requests for example. Communications link 318 typically includes a delivery network 307 making a direct or indirect communication between capture devices and/or systems 301, servers 303, user system 220, and server system 260, irrespective of physical separation

Processing system 300 is capable of delivering and exchanging data and images between capture devices and/or systems 301, servers 303, and workstations 305 through communication links 318 and/or network 307. Processing system 300 is configurable to suit the check processing needs of small business and banks to large financial institutions, including specifying sort patterns, endpoints, users, devices, calendaring and the like. Moreover, processing system 300 is managed using an administration tool capable of providing logging of errors and warnings, the ability to monitor tasks, applications, devices, backing up data, and restoring data. Through processing system 300, operators at workstations 305 can communicate over network 307 or communication links 318 with each capture devices and/or systems 301, servers 303 and with other systems and devices coupled to network 307 to capture images and/or to exchange electronic files according the Check21 Act.

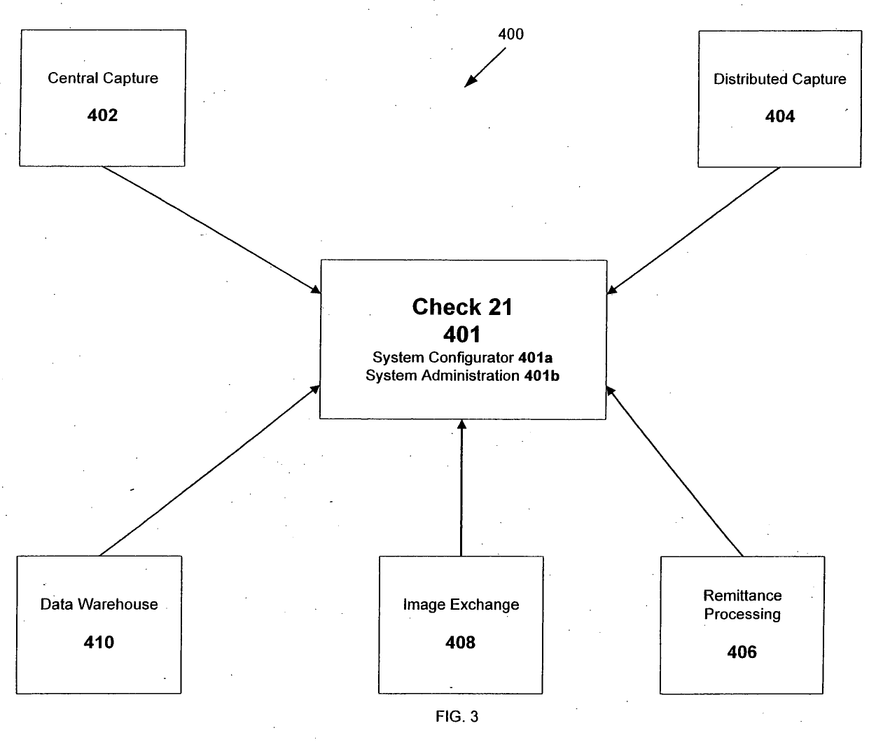

Referring now to FIG. 3, a diagram of an image based check clearing and processing solution 400 is shown comprising five high level modules, implemented by the processing system in FIG. 2. Check21 modules 401 preferably include but are not limited to, payment processing modules known as central capture 402, distributed capture 404, remittance processing 406, image exchange 408 and data warehouse 410. Modules 401 uses the same operator interface, components and the same .NET Web Service screen formats and processes as previously described. Thus, an operator trained on one module can easily maneuver other modules 401 of solution 400. For example, functionality such as amount entry and item correct have the same interface, format and process as in prime capture 402 as in image exchange 408 and all the other modules 401 offering amount entry (AE) and item correct (IC) functionality, and still further because all modules use the same platform for AE, IC, and reconciliation (balancing), solution 400 requires a single training for users of system 400.

Each of the Check21 modules 401, their sub-modules (logical processing components) or parameters within such sub-modules may be activated or deactivated depending on the customer requirements or processing system 300 interoperability with legacy systems or components performing some of the modules 401 functionality. Check21 solution 400 includes a system configurator 401a and administrator 401b enabling a system user to activate or deactivate any of the modules 401, their sub-modules, or parameters within such sub-modules, and to configure a Check21 Act processing system 300 with custom work flow processes to meet an end users' individual application and solution requirements. Check21 Act system configurator 401a enables centralized configuration of modules 401 and their functionality, configuration of users, sites, devices, endpoints (Check21 sending destinations) and processing parameters, and defines integrated sort pattern specifications (decisions based on check code line criteria information which determines an Image endpoint). Check21 Act system administrator 401b enables administration of modules 401 and their functionality with centralized event logging and monitoring, including monitor and management reports from a central location. Moreover, administrator 401b maintains and administers the interface files between legacy and other systems interfacing with modules 401 and/or processing system 300. Processing system 300 provides a single application to perform capture of check images and data, power encode and reject encode including a full range of functionality, such as MICR and OCR reads, microfilm, endorsing and encoding.

Central Capture

Central capture module 402, of modules 401, of solution 400 controls operation of prime capture 302 readers/sorters by interfacing and communicating with prime capture 302 devices. Central capture module 402 includes many industry standard Check21 Act image file capture processes, interfaces and capture engines enabling communication with multiple vendor prime capture 302 readers/sorters which capture image files from paper checks. Central capture module 402 interfaces and integrates seamlessly to legacy prime capture 302 devices and other server-based capture devices 301.

Moreover, central capture module 402 includes applications for data entry and item validation, such as CAR/LAR (courtesy amount read/legal amount read); ICR (intelligent character recognition) applications for automatically locating and reading handwritten numeric entries on Items, and other tools to convert handwritten text and numbers into machine readable character strings and documents; and image quality analysis (IQA) (Check21 standard parameters for image quality audit), usability (Check21 standard parameters for image usability) reconciliation, reports, and flexible data extraction. Central capture module 402 includes other types of third party image recognition services, such as courtesy and legal amount read (CAR/LAR) which read handwritten, machine printed, E13B, optical character recognition (OCR) OCR A, OCR B fonts and character recognition schemes, included in central capture module 402 of processing solution 400. Central capture module 402 utilizes Check Image Interrogation application to compare the transaction amount written on the Item captured to the amount keyed in by the operator. Such capture devices 301 significantly reduce the amount of data entry, keying required, item correction and/or amount entry.

Central capture module 402 controls operation of capturing and processing ATM envelopes. Central capture module 402 compares the amount of ATM deposited data captured using capture devices 301 to database server 308 information containing the amount of the ATM deposit keyed in by the customer during the ATM transaction.

Central capture module 402 utilizes image-based applications that provide data entry and data completion capabilities for Items that were not successfully captured by capture devices 301 (e.g. during the CAR or ICR process). Data completion consists of amount entry, which provides a fast way to complete Image files that are missing the amount field data, while item correction allows complete check code line correction. In addition, central capture module 402 includes applications for image quality review assessing the image quality of each Item and its image usability. If an Image file is identified as either having a missing data or a suspect image, central capture module 402 can request process 300 to recapture or re-scan the Item using capture device 301 to rescan and replace the suspect image with a corrected image file.

Central capture module 402 utilizes an ICR engine for locating and reading the check MICR E13B font code line information. Central capture module 402 compares this MICR E13B font code line at the bottom of the check with the Image file captured utilizing capture devices 301, and central capture module 402 utilizes this approach to correct the MICR code line read errors when processing images files from paper capture, Check21 Act X9.37 format and other industry check image electronic files.

Central capture module 402 utilizes an image-based reconciliation tool capable of balancing (reconciling) blocks of Items and compiling a total value of a number of block of Items from check image files. Reconciliation provides an operator of processing solution 400 with on-screen image balancing at required control levels: such as transaction, batch or block levels and can be used for inclearing (incoming Items) and proof of deposit POD (outgoing image files or transit work) Item processing. Central capture module 402 reconciliation tool includes smart balancing technology (allows an operator to perform deposit review and research, reconcilement/balancing), which identifies transaction, batch or block of Items with reconciliation errors or out-of-balance errors. Within reconciliation tool, central capture module 402 may provide system advice such as customer, inter-bank and teller feedback or operations advice. Moreover, Central capture module 402 includes ATM balancing tools employing the same functionality as reconciliation smart balance, but allows for the ability to view all ATM envelope images in the same reconciliation application.

Central capture module 402 includes a complete and comprehensive reporting and extraction tool for daily operations, statistical and MIS reporting. Moreover, Central capture module 402 includes flexible extraction formats allowing the transfer of data to other user systems or applications. Reports can be scheduled for auto creation, printing or viewing as well as archiving or sending to designated email lists. Various data extraction and query tools are included, enabling an operator to extract specific data for analysis.

Central capture module 402 includes a workflow management application. Workflow management is a real-time tracking tool for monitoring various capture device 301 at each point in the workflow process within processing system 300. Workflow management monitors, for example, the type of Items being captured at each capture device 301, the number of Items being captured at each capture device 301, the image file quality, the transaction, batch or block Item amounts; the operators utilizing processing system 300 and work loads at each processing point, capture, distributed capture, image exchange, AE, IC, reconciliation, ATM capture, and capture device 301. Workflow management enables an operator of processing solution 400 to view system statistics and provides the ability to change work flow priority or to control capture device 301 operations, priority, batch or block and adjust or rededicate processing system 300 components.

Central capture module 402 includes a seamless interface to image exchange module 408 and other modules 401, providing an integrated image based check clearing and processing solution 400. Incoming Items are captured as image files by central capture module 402 and the image files and the data extracted from such image files is transmitted to image file server 306 for temporary storage, or such image files may be directly transmitted to database server 308 for long term storage. Outgoing Items (X9.37 image files of checks) are transmitted to selected endpoints with outside clearing and processing solution 400. Additionally, central capture module 402 interfaces with legacy systems or other server-based systems enabling the end user to continue using such systems for deposit review and research, reconcilement and balancing, enhancing those systems by adding stand-alone module(s).

Central capture module 402 seamlessly interoperates with the other modules 401 of processing solution 400 or central capture module 402 may independently interface/integrate with third party legacy and server based check processing and capture equipment or systems requiring interoperability by the customer.

Distributed Capture

Distributed capture module 404, of modules 401, of solution 400, controls operation of distributed capture 304 readers/sorters by interfacing and communicating with distributed capture 304 devices servicing previously unserviceable branches, corporate and merchant capture points remote from the main components of processing solution 400. In this application, use of the adjective “distributed” means that the device (scanner, computer, etc.) is at a location physically apart from the central processing center. Distributed capture module 404 enables capture of code lines and image files close to the point of presentment, resulting in a direct method of entering transaction information into image file server 306 and/or database 308, thus reducing the courier and transportation cost of moving Items to a central processing center. Distributed capture module 404 includes many industry standard Check21 Act image file capture processes, interfaces and capture engines, including features set forth in central capture 402 in one application enabling communication with multiple vendor distributed capture 304 readers/sorters, which capture image files and codes from smaller volumes paper checks typically in remote locations such as corporations, branch banks, retail operations, payment walk-in locations, and the like. Distributed capture module 404 captures paper checks on low cost desktop scanning devices close to “point of presentment” of the check, for entry into Check21 Act processing system 300.

Distributed capture module 404 supports front branch teller, branch back office capture, merchant and corporate capture functionality from remote distributed capture locations, including remittance processing at remote sites. Distributed capture module 404 includes a seamless interface to the central capture module 402 and other modules 401, providing an integrated image based check clearing and processing solution 400. Incoming Items are captured as image files by distributed capture module 404 and the image files and the data extracted from such image files is transmitted to image file server 306 for temporary storage, or such image files may be directly transmitted to database server 308 for long term storage.

Distributed capture module 404 interfaces and integrates seamlessly to legacy distributed capture 304 devices and other server-based capture devices 301, or directly to central capture module 402. Distributed capture module 404 supports tightly integrated applications (quality standards set by the industry) to prevent fraud, and utilizes cross-site keying (ability to key and correct images across all remote sites), and remote or central data entry processes. Additionally, central capture module 402 controls all reconciliation and reporting for distributed capture module 404 and uses the same function to process both the ACH and Check21 files so 100% of paper checks/items are processed electronically.

Distributed capture module 404 incorporates the same data entry and Item validation applications as central capture module 402, and such applications are available on the remote applications, including CAR/LAR and ICR, image quality audit and usability; data completion (amount entry and item correction), as well as other types of third party image recognition services which read handwritten, machine printed, E13B, optical character recognition OCR A, OCR B fonts and character recognition schemes, are included in distributed capture module 404 of processing solution 400.

Front branch teller capture includes capturing customer transactions when the teller receives the check, via a distributed capture device 304, such as medium or low speed check image and MICR readers and sorters integrated into a branch teller platform under the control of distributed capture module 404. Distributed capture module 404 can be integrated into a legacy branch teller platform and using CAR/LAR, check amounts can be recognized and processed quickly. Deposits and payments information captured during distributed capture module 404 can be balanced with processing solution 400 transaction reconcilement application interfaced directly with front branch teller capture. Distributed capture module 404 maintains balanced transaction information, and such information is aggregated and transmitted to data server 308 the central site for data entry, reconciliation and posting. Data entry, reconciliation, item correction and amount entry may be performed remotely by the teller through distributed capture module 404, or in the central site under image based check clearing and processing solution 400.

Back office branch capture includes batch capturing of customer transactions in the back office after teller receives the check on distributed capture devices 304 such as medium or low speed check image and MICR readers and sorters integrated into a branch teller platform under the control of distributed capture module 404. Throughout the day, transactions received by tellers may be collected and batched together for back office capture. At one or more specified times during the day, the customer transactions are batch captured and the image files are transmitted to data server 308. Distributed capture module 404 maintains balanced transaction information and such information is aggregated and transmitted to data server 308, the central site for reconciliation. Data entry, reconciliation, item correction and amount entry may be performed remotely in the back office through distributed capture module 404, or in the central site under image based check clearing and processing solution 400. Images files, data and check code lines are transmitted to data server 308, the central site for data entry, reconciliation, item correction and amount entry.

Corporate and remote capture includes capturing corporate deposits at the corporate office on distributed capture devices 304, such as a medium or low speed check image and MICR readers and sorters, integrated into a corporate capture platform under the control of distributed capture module 404. Distributed capture module 404 maintains balanced transaction information, and such information is aggregated and transmitted to data server 308, the central site for reconciliation. Data entry, reconciliation, item correction and amount entry may be performed remotely in the corporate office through distributed capture module 404, or in the central site under image based check clearing and processing solution 400. Images files, data and check code lines are transmitted to data server 308, the central site for data entry, reconciliation, item correction and amount entry. Such capture devices 301 significantly reduce the amount of data entry, keying required, item correction and/or amount entry.

Upon capture of an image file, processing solution 400 assesses image quality and usability for each Item captured as an image file during central capture 402 and distributed capture 404. If image files are incomplete, processing solution 400 preferably provides data entry and completion capabilities for Items that were not successfully captured during CAR, LAR, or ICR. Amount entry enables an operator to quickly key in correct or missing amount fields. Correction enables an operator to correct code line information such as MICR and the like. Balanced transactions are aggregated and sent within processing solution 400 for reconcilement and posting. Moreover, processing solution 400 enables customized archiving of image files and data for each capture point and database, and preferably includes various research, reporting and query applications to sort and compile such image files and data.

Distributed capture module 404 seamlessly interoperates with the other modules 401 of processing solution 400, or distributed capture module 404 may independently interface/integrate with third party legacy and server based check processing and capture equipment and/or systems currently in use by the customer as legacy equipment or systems requiring interoperability by the customer.

### Remittance Processing

Remittance processing module 406, of modules 401, of solution 400 performs traditional retail remittance processing (check clearing tasks—“the task of paying and balancing accounts”), wholesale statement, open item processing and checks “only” processing, tightly integrated to merchant capture or stand-alone, remotely, using image files to accomplish clearing tasks, as well as integrating the functionality and supporting central capture 402 and distributed capture 404. Remittance processing module 406 installs the same components to drive any industry image check processing sorters and/or image check scanners, including those set forth in central capture 402 and/or distributed capture 404. By using Check21 image files, or ACH files to expedite transit clearing and by enabling the opportunity to truncate remittance deposits at the source, remittance processing 406 provides system resource cost savings. Remittance processing module 406 is a single system for processing solution 400, enabling functionality such as proof of deposit (POD) and remittance processing, and eliminating the need for two separate systems.

Remittance processing module 406 uses the same ICR engine, to read the MICR code line on the checks, as used in central capture module 402 and/or distributed capture module 404 to read the OCR font on payment stubs. Moreover, remittance processing module 406 includes flexible scan-line definition, a processing solution 400 configurator which allows the parsing and capture of all data on the payment stubs. Remittance processing module 406 is capable of tracking every Item to its payment source, allowing for the automation of all processing exceptions. Remittance processing module 406 will automatically reverse the original credited payment account upon the return of a check for insufficient funds, whether check is paper, image files, or image replacement documents (IRDs).

Remittance processing module 406 integrates data correction and balancing applications in a traditional, full image, two pass remittance process. Pass one is capture, correction and storage of image files and data in database server 308 for image correction and archival use. Pass two is remittance and balancing applications, such as (1) screen balancing of singles and multiples on all transactions including penny substitution (plug penny value from $0.01 to $0.99 to put transactions in balance and write this amount off rather than spend the postage and the cost to re-bill the customer), (2) overpay limits (the process of not accepting a payment if it is $XXX.XX <a set parameter> over the amount due; for example a customer puts in their mortgage payment check instead of their phone bill check into the wrong envelope), (3) total due balancing (the ability to calculate from the payment stub or account into the amount of the payment due any later charges or penalties) and render a decision requiring acceptance or refusal of the payment (check, ACH or Check21 electronic file) based there on, (4) permutation balancing (the process in which during multiple payments <more than one check and/or more than on payment stub,> such application computes every combination of payments due, minimum payments, and late fees to decide what the customer intended to pay without operator intervention), and (5) force balancing (the process in which the transaction or set of transactions are not in balance, but are manually accepted and the work is processed so the checks, ACH or Check21 file is sent out <these items are verified for the correct amounts>. A manual adjustment is later made to the payment credit file), resulting in faster credits to customer accounts.

Remittance processing module 406 utilizes database server 302 SQL database applications to track payment sources. Remittance processing module 406 tracks every check captured to every remittance payment and may automate all processing exceptions, and returned checks, whether by ACH, X9.37 image, paper or IRD. If insufficient funds, remittance processing module 406 will automatically report such insufficient funds to the payor account and reverse from the original credited payment account, whether legacy system or Check21 X9.37 compatible.

If required by the end processing center, remittance processing module 406 may utilize an integrated power encoder application for encoding outgoing paper checks, or eliminate power encoder, by printing IRDs. Remittance processing module 406 enables encoding of selected Items which are destined for paper endpoints.

Remittance processing module 406 utilizes exception handling including over/short reconciliation, daily cash reconciliation and payment investigation applications. Remittance processing module 406 may utilize CheckFree's API Software for converting checks image file and data to automated clearing house (ACH) transactions, wherein processing solution 400 processes all the exception items that cannot be processed by ACH, using the processing solution 400 image exchange 3D application. An ACH transaction and Check21 image files allows a financial institution to debit the customer's account through the ACH method and Check21 file method and then credit an account owned by the payee. The ACH method utilizes electronic transfers as opposed to the conventional clearing path used by banks and other financial institutions in clearing a check.

The payee must convey transfer information regarding an account to be credited to the customer's bank. The payee's account information may be included in the image of the check that is transferred. For example, if the item scanned is a check, an endorsement stamp may be added to the image which includes the bank and account number to be credited. Alternatively, the bank information could be added to the image file as a separate line item. The invention is able to process both ACH and the exceptions as Check21 image document files and IRDs. This process is also used in remote capture and merchant capture.

Remittance processing module 406 seamlessly interoperates with the other modules 401 of processing solution 400, or remittance processing module 406 may independently interface/integrate with third party legacy equipment and/or systems currently in use by the customer as legacy and server based check processing and capture equipment or systems requiring interoperability by the customer.

### Image Exchange 3D

Image exchange 3D module 408, of modules 401, of solution 400 performs payment processing as an integrated image exchange for both incoming and outgoing processes utilizing sub modules incoming exchange and outgoing exchange for paperless processing. Image Exchange 3D module 408 enables check truncation at the source, and conversion of non-image accounts to image accounts, eliminates item capture pass with incoming image clearings, eliminates physical encoding of outbound cash letters, and improves fraud detection and customer service.

Incoming Exchange

Incoming X9.37 image files are received in image exchange 3D module 408 from all major image exchange networks (FRB, SVPCo, FISERV, and the like), validated, and are processed through the image exchange 3D module 408 incoming process. These files are merged into the processing solution 400 or into a legacy system by the capture process in central capture module 402. Incoming exchange process in image exchange 3D module 408 contains multiple processes that are configurable under the system configurator. For example, process iSynch opens and processes an incoming (or outgoing) X9.37 image files and uses ICR and CAR/LAR engines to compare each image to the code line in the X9.37 file and to check the total amount of all items in the file for accuracy and completeness before the image file is released for processing, thus validating the X9.37 images plus data before processing.

Pre-processor reads the X9.37 incoming files and validates the file header, trailer and all the record types against the ANSI X9.37 specifications. Virtual capture process creates jobs or blocks of work (items) from any incoming industry electronic files ECP (electronic check presentment), ECPI (electronic check presentment with Image), ICL (image cash letter), X9.37 (ANSI Specification) and performs sort pattern (SPN) verification. Thereafter, Items are then captured by central capture 402 and transmitted to database server 308 of processing solution 400. Duplicate checking process sends all image files to Check21 data warehouse module 410 to compare and determine whether a similar Item has been processed before, and also whether in paper, IRD, electronic files or from X9.37 files.

Incoming exchange integrates with and utilizes the image quality analysis (IQA) and image usability analysis (IUA) components of processing solution 400, defined in the Configuration Module and linked to the sort pattern (SPN) parameters by item type.

Outgoing Exchange

Outgoing exchange automatically generates and formats electronic cash letter files, captured by capture devices 301 or any interfaced legacy system controlled by central capture module 402, into X9.37 standard Check21 image files, which are then queued for transfer through processing solution 400 to web server 310 and to a designated corresponding financial institution. Outgoing exchange creates file formats which are compatible with legacy check processing and capture systems.

Moreover, outgoing exchange integrates with and utilizes the image quality and usability analysis components of processing solution 400, wherein such quality and usability analysis processes may be performed on the X9.37 standard Check21 files prior to transfer. X9.37 image files that do not comply with quality and usability are routed to work station 312 for manual review using Item review application. Item review application performs quality and usability analysis review of the X9.37 image files and detects images failing to meet quality and usability requirements. If an Item fails, Item review processing solution 400 will call for re-capture of the Item, utilizing rescan manager application.

Image exchange 3D module's 408 rescan manager application creates “pick lists” of Items to be rescanned by job, block or sorter pocket, indicating the physical location of a paper check to be retrieved and rescanned using capture devices 301. Items selected for re-capture are routed back to capture devices 301 and re-captured. The re-captured image file and check code line (MICR data printed on the bottom of the check) are matched to the previous Item record in database server 308, thus, attaching the recaptured image to its pre-existing data code line file. The X9.37 generator of image exchange 3D module 408 merges the re-captured image utilizing the rescan manager application. Thereafter, image exchange 3D module 408 calls iSynch application to compare code line and amount, and to validate the two data fields match in order to verify a complete and balanced Item file. Once an Item's image file passes Item review with an accepted X9.37 image files, image exchange 3D module 408 calls the X9.37 generator application, a function within Image exchange 3D module's 408. The X9.37 generator interfaces with the cash letter manager, whether for legacy or Check21 systems, and creates electronic files in standard ECP/ECPI, ICL, ECPD, IRCL or X9.37 formats.

Alternatively, the X9.37 generator may optionally output Check21 IRD files for adhoc or batch printing of image replacement documents (IRDs), which are legal checks reprinted from a Check21 check image of a captured Item. X9.37 generator creates a complete audit trail and tracking of the IRDs preventing duplicate IRD production.

Image exchange 3D module 408 includes a transmission gateway application, which manages the transmission and interfaces between financial exchange partners, as defined under the Check21 Act.

Image exchange module 408 seamlessly interoperates with the other modules 401 of processing solution 400, or image exchange module 408 may independently interface/integrate with third party legacy and server based check processing and capture equipment and/or systems currently in use by the customer as legacy equipment or systems requiring interoperability by the customer.

Check21 Data Warehouse

Check21 data warehouse module 410 performs duplicate checking, automated return of Items, and image file archiving of Check21 data or interfaces with any legacy or server-based financial system requiring Check21 requirements for duplicate checking and archiving of Check21 data. Check21 data warehouse module 410 is scalable for any size financial institution and provides an administration application which allows an operator set retention periods for all data, including ten year archival of image files as required under the Check21 Act.

Check21 data warehouse module 410 is a payments data repository, wherein analysis of information, whether paper, X9.37 image files, data or IRDs, is conducted for identification of duplicate sends and receives of the same check. Check21 data warehouse module 410 provides check research and reporting capabilities. Reports include standard reports and operator customized reporting capabilities. Check21 data warehouse module 410 provides data mining functionality including returns history, method of payment, and multiple check payments for automation of returned checks collected during remittance capture module 406.

Check21 data warehouse module 410 automates ACH returns and Check21 X9.37 returns. Check21 data warehouse module 410 creates derived returns, notification of change, refused notification of change, dishonored and contested dishonored returns. By tracking the original source of the Item and the original depositor, Check21 data warehouse module 410 generates reporting for total returns automation.

Check21 data warehouse module 410 seamlessly interoperates with the other modules 401 of processing solution 400, or Check21 data warehouse module 410 may independently interface/integrate with third party legacy and server based check processing and capture equipment and/or systems currently in use by the customer as legacy equipment or systems requiring interoperability by the customer.

The unique design of the processing solution 400 components and databases provide the ability to archive images and data for research using a sophisticated search engine tools. The retention periods for archived data and images are settings in the C21A system configurator.

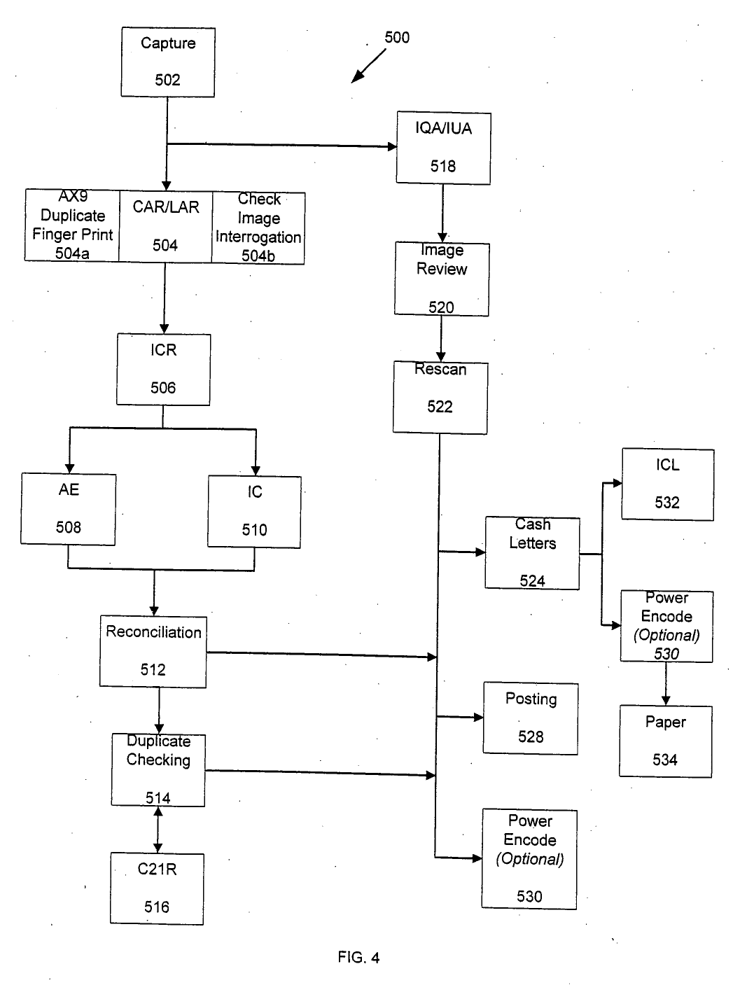

Referring now to FIG. 4, a flow diagram is shown that illustrates a preferred step in a process 300 for central capture module process 500. Central capture module 402, of modules 401, of solution 400 controls operation of prime capture 302 readers/sorters by interfacing and communicating with prime capture 302 devices. Central capture module process 500 begins with capture module 502 which reads, images, endorses (prints a document identification number (DIN)) on the back of the check), and sorts paper checks to an endpoint pocket location on an industry standard check sorter, whether located at the central processing site or attached remotely to the central site. “Module,” as used herein, means a modular set of instructions or protocol to interoperate or communicate with a specific hardware or perform a specified process or application. Capture 502 module (application) includes processes for storage of image files of the checks and other control tickets captured, as well as item data captured, including the MICR (magnetic Ink) and any Check21 image quality and/or usability data output by the capture device 301. Process 300 captures the depositor's information in the image proof of deposit (Image POD) as well as all the payment billing information from remittance processing module 406, both later stored in the Check21 data warehouse 410 for returns automation.

Next, process 500 calls CAR/LAR module 504. CAR/LAR electronically reads the dollar amount printed or written in each image file. CAR reads the numeric courtesy amount, while the LAR reads the legal amount from the image file. If CAR/LAR module 504 fails to read the check amount, then process 500 preferably requires the image file to be processed on an amount entry (AE) 508 workstation 312, wherein an operator reviews the image and keys in the amount of the check.

Next, process 500 calls ICR module 506. ICR is a module designed to optically read the E13B magnetic ink font from the image of a check. Additionally, ICR module 506 preferably reads the MICR code line irrespective of whether the check is captured upside down, backwards, or both. Moreover, ICR module 506 preferably reads Items that are rejected by capture devices 301 under an ICR correction routine. Lastly, if ICR module 506 fails to read the Item, process 500 calls item correction (IC) 510, wherein an operator at work station 312 reviews the image and keys in the correction(s) to the MICR code line in the appropriate boxed fields located directly below each field of the MICR code line of the check displayed on the screen.

Next, AX9 module 504a generates a unique electronic finger print or digital signature for each check imaged by processing solution 300 and stores this unique file for each item in the Check21 data warehouse 410, to be utilized along with the MICR codeline to test for duplicate checks in duplicate checking module 514.

Next, check image interrogation module 504b captures additional information, such as payor, payee, name and address, water mark, signature or any other field on the check, and performs image interrogation. Such information is stored in the Check21 data warehouse 410 for future search, research, fraud detection, and data mining capabilities.

Next, reconciliation module 512 performs balancing of any group(s) of checks in which the total dollar value captured is not equal to the expected total dollar value. Reconciliation module 512 preferably is the same process throughout processing solution 400, wherein reconciliation module 512 interfaces to legacy and other server systems for both paper and Check21 processing, using the same module. As mentioned earlier, reconciliation module 512 includes “Smart Balancing” with standardized image processing screens throughout all modules.

Next, duplicate checking module 514 performs duplicate check analysis by comparing image files of all Items since the same check could be presented multiple times in the form of an IRD (reprinted paper copy of a check image and MICR code line on the bottom), the original paper check, X9.37 image file, or an industry electronic file. Duplicate checking module 514 stores the MICR codeline, AX9 504a file, and any image interrogation data information from image interrogation module 504b on the C21R 516 Check21 data warehouse module 410. Duplicate checks are flagged and reported by duplicate checking module 514 and removed from the cash letters module 524 (a listing of all items and bundles sent to a destination), posting module 528 (module that creates and updates client account information) and/or power encode module 530 (module running on a document processing machine that encodes the MICR amount on items that are not Check21 items).

Next, IQA/IUA module 518 analyzes the image quality and image usability of a check image file. Image files failing the minimum image quality and usability standards are processed by image review module 520, wherein such image file is presented to an operator at workstation 312 and the image is accepted or rejected. Upon rejection, the rejected items will be listed, retrieved and presented to rescan module 522 workstation 312 for an operator to rescan and re-image the failed image file. Moreover, rescan module 522 includes the ability to rescan “piggy-backed checks.” Piggy-backed checks are checks that stick together as one Item while being fed through a check capture device 301. Rescan module 522 enables image files to be captured and added to the work flow for processes CAR/LAR 504, ICR 506, AE 508, reconciliation 512, duplicate checking 514, C21R 516, IQA 518 and image review 520 modules.

Next, upon completion of reconciliation module 512 and duplicate checking module 514, the check processing work is sorted into “on us” or “transit” work. “On us” work includes image files that belong to the central site institution and proceed to posting module 528 on such institution's core legacy system. The remaining image files and paper checks are outgoing or “transit” items. All such transit items are separated into cash letters which are detailed listings of all items being sent to an endpoint. For paper items (cash letter 524), reports are printed with the listed image files, which may or may not be power encoded module 530 (the process which feeds the items through a check sorter and encodes the amount of the check in the lower right corner of the check in magnetic ink (MICR)). Moreover, image files and data, electronic cash letters, or image cash letters (ICL) 532 are created in an X9.37 file format for transmission through the transmission gateway in processing solution 300.

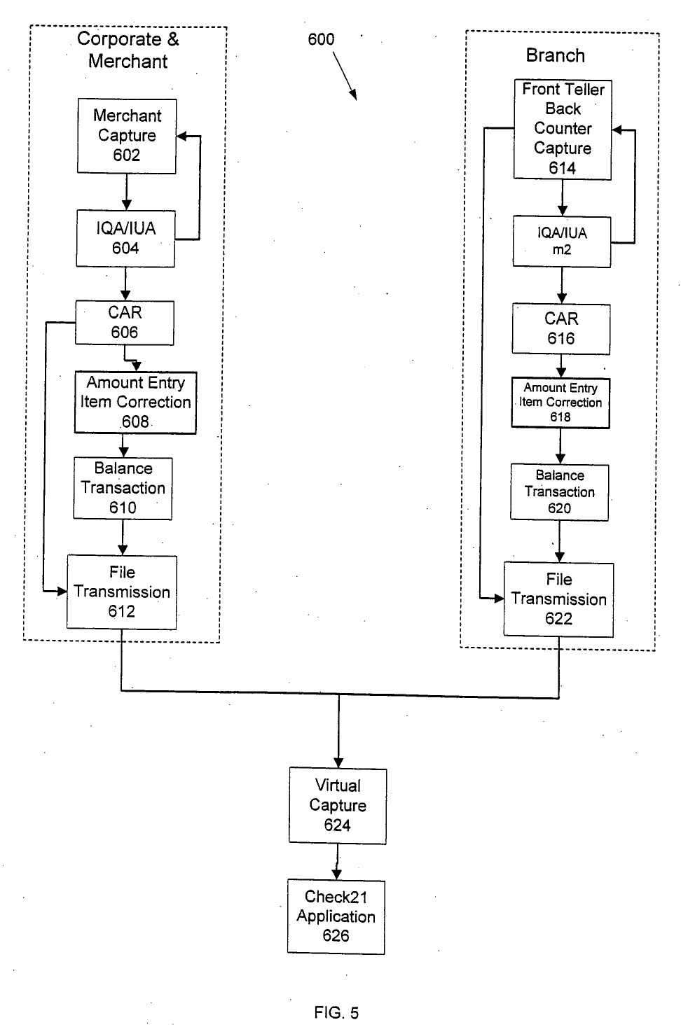

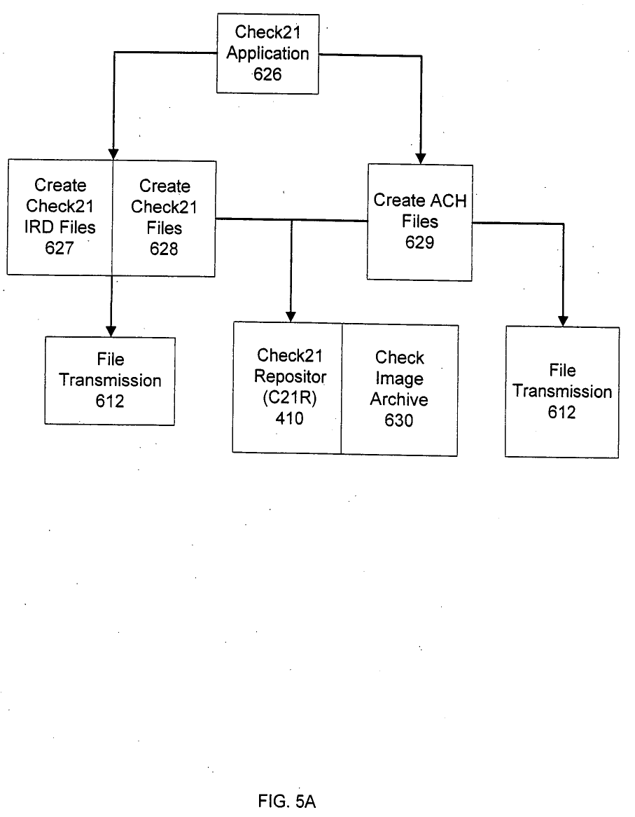

Referring now to FIG. 5, a flow diagram is shown that illustrates a preferred step in a processing solution 400 for distributed capture module process 600. Distributed capture module 404, of modules 401, of solution 400, controls operation of distributed capture 304 readers/sorters by interfacing and communicating with distributed capture 304 devices servicing previously unserviceable branch, corporate and merchant capture points remote from the main components of processing solution 400. Distributed capture module process 600 supports front branch teller, branch back office capture, and merchant and corporate capture from remote sites. Distributed capture module process 600 begins with corporate/merchant capture module 602, the process of feeding check(s) through a table top check image capture device 301 interfaced to a PC workstation 312, or to an intelligent scanner with its own IP address.

The PC workstation 312 distributive capture module process 600 application is configured to allow or disallow CAR/IQA module 604 and balance transaction module 606. In balance transaction module 606, the Items are captured (image files and the MICR codeline) and stored as a file for files transmission module 608. The corporate or merchant capture module 602 validation process is configured at workstation 312 by setting parameters in the configuration system module of process 300. Moreover, distributive capture module process 600 enables validation of CAR (Courtesy Amount Read), IQA Image Quality Analysis), Amount Entry, Item Correction and Balancing in the remote distributed capture site, or in the central processing site. Preferably, any combination or duplication of processing is available in distributive capture module process 600.

Corporate/Merchant Capture

Corporate/merchant capture module 602 captures the Items on distributed capture 304 readers/sorters and calls CAR module 604, wherein a CAR engine reads the amount of the check. If CAR module 604 fails to read the amount of the check, CAR module 604 requires the operator to key in the amount as displayed on the PC workstation screen 312 (amount entry 608). If image quality analysis (IQA) fails minimum image quality and usability standards, distributive capture module process 600 prompts the operator on the PC workstation 312 to view the image captured and to rescan the check. If a MICR codeline read failure occurs, distributive capture module process 600 initiates item correction process, wherein an operator on the PC workstation 312 corrects the MICR characters that did not read or failed to read correctly on the PC workstation 312 while viewing the image on the PC. In this case, where all validation functions are remotely processed, the balance transaction 610 process analyzes all captured Items to determine whether such Items are equal in amount to a predetermined total amount. If such Items are not equal to a predetermined amount, distributive capture module process 600 initiates an operator on the PC workstation 312 to review all check images and their amounts on the PC workstation 312 and re-key any Item amount errors to the checks or the control amount ticket in order to balance the group transaction. Moreover, this balance transaction process is preferably identical across all modules and applications of process 300, whether processed remotely or in the central site.

Branch Capture

Branch capture module comprises both Front Teller Capture and Back Counter (Office) Branch Capture 614. Front Branch Teller Capture module 614 captures customer deposits on a distributed capture 304 check image scanner, preferably in communication with a branch PC teller workstation 312.

PC workstation Branch Capture application, similar to Corporate/merchant capture module 602, is configured to allow or disallow CAR/IQA module 616 and balance transaction 620. In the balance transaction 620, the Items are captured (imaged and the MICR codeline captured) and stored as a file for files transmission 622 to the central site for reconciliation, item correction, amount entry, and the like in process 300.

Branch capture module 614 captures the Items and calls CAR module 616, wherein a CAR engine reads the amount of the check. If CAR module 616 fails to read the amount of the check, CAR module 616 prompts an operator to key in the amount as displayed on the PC workstation screen 312 (amount entry 618). If image quality analysis (IQA) fails minimum image quality and usability standards, distributive capture module process 600 prompts the operator on the PC workstation 312 to view the image captured and to rescan the check. If an MICR codeline read failure occurs, distributive capture module process 600 initiates item correction process, wherein an operator on the PC workstation 312 corrects the MICR characters that did not read or failed to read correctly on the PC workstation 312 while viewing the image on the PC. In this case, where all validation function are remotely processed, the balance transaction 620 process analyzes all captured Items to determine whether such Items are equal in amount to a predetermined total amount. If such Items are not equal to a predetermined amount, distributive capture module process 600 initiates an operator on the PC workstation 312 to review all check images and their amounts on the PC workstation 312, and to re-key any Item amount errors to the checks or the control amount ticket to balance the group transaction. Balanced transactions are aggregated and sent to the central site for reconciliation. Reconciliation, item correction and amount entry are handled remotely, or in the central site under process 300. Front Branch Teller capture typically processes small numbers of Items (deposits) because the teller is face to face to the customer.

Back Counter (Office) Branch Capture module 614 captures batches of work on an image scanner capture device 301 for transmission of check image files and data to the central capture module 402. The number of Items captured on back counter is larger in volume than front branch teller capture, but often there is not enough operator time to validate, correct or key amounts in the branch site. Each teller's work, comprised of multiple deposits, is processed together as one capture. Thus, image files and check codeline data are sent to the central site for reconciliation, item correction, amount entry and the like a process 300.

Virtual capture module 624 captures all check data and images files transmitted from file transmission 612 and 622. Virtual capture module 624 manages jobs or blocks of work (Items) from any capture device 301 having industry standard electronic files (ECP, ECPI, ICL, X9.37), and performs sort pattern (SPN) module verification. Items are then captured and transmitted to database server 308.

Referring now to FIG. 5A, a flow process diagram is shown that illustrates corporate capture module 602, distributed capture module 600, branch capture module 614, and back counter (office) branch capture module 614, wherein any jobs, blocks of work or Items from any capture device 301 are created by process control 626 into Check21 IRD files 627 Check21 files (X9.37) 628 or ACH files 629. Check21 application 626 tests and processes each item for Check21 process IRD files 627, Check21 files (X9.37) 628, or ACH files 629. Upon creation of Check21 IRD files 627 and Check21 files (X9.37) 628, such files are transmitted by transmission module 612 to bank or service bureau. Upon creation of ACH files 629, such files are transmitted by transmission module 612 to bank or service bureau. All Check21 files (Items), Check21 process IRD files 627, Check21 files (X9.37) 628, and ACH files 629 preferably are stored in Check21 data warehouse module 410. Check21 data warehouse module 410 contains and captures, via process 300, the depositor's and bill payers records regarding both deposits and payment for returns automation.

All check images captured and processed in process solution 400, process IRD files 627, and Check21 files (X9.37) 628, are transmitted to check image archive 630 for later retrieval and processing. In the process of creation of ACH files 629, wherein check image files are attached and these files are transmitted to a check image archive 630 for later retrieval process.

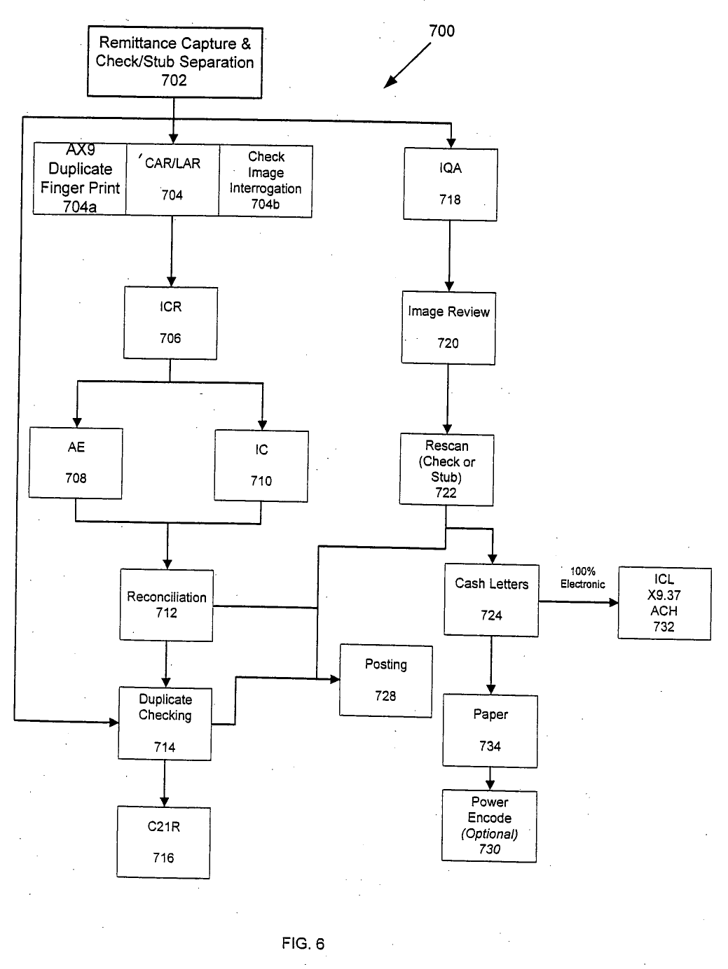

Referring now to FIG. 6, a flow diagram is shown that illustrates a preferred step in a processing solution 400 for distributed capture module process 700. Distributed capture module 404, of modules 401, of solution 400 controls operation of distributed capture 302 readers/sorters by interfacing and communicating with distributed capture 302 devices. Distributed capture module process 700 begins with capture module 702 which reads, images, endorses (prints a document identification number (DIN)) on the back of the check), and sorts paper checks to an endpoint pocket location on an industry standard check sorter, whether located at the central processing site or attached remotely to the central site. “Module,” as used herein, means a modular set of instructions or protocol to interoperate or communicate with a specific hardware or perform a specified process or application. Capture module 702 (application) includes processes for storage of image files of the checks and other control tickets captured, as well as item data captured, including the MICR (magnetic Ink) and any Check21 image quality and/or usability data output by capture device 301. Process 300 captures the depositor's information in the image proof of deposit (Image POD), wherein such information is later stored in the Check21 data warehouse 410 for returns automation.

Next, process 700 calls CAR/LAR module 704. CAR/LAR electronically reads the dollar amount printed or written in each image file. CAR reads the numeric courtesy amount, while the LAR reads the legal amount from the image file. If CAR/LAR module 704 fails to read the check amount, then process 700 preferably requires the image file to be processed on an amount entry (AE) 708 workstation 312, wherein an operator reviews the image and keys in the amount of the check.

Next, process 700 calls ICR module 706. ICR is a module designed to optically read the E13B magnetic ink font from the image of a check. Additionally, ICR module 706 preferably reads the MICR code line irrespective of whether the check is captured upside down, backwards, or both. Moreover, ICR module 706 (under an ICR correction) preferably reads Items routine (that are rejected by capture devices 301). Lastly, if ICR module 706 fails to read the Item, process 500 calls item correction module (IC) 710, wherein an operator at work station 312 reviews the image and keys in the correction(s) to the MICR code line in the appropriate boxed fields located directly below each field of the MICR code line of the check displayed on the screen.

Next, digital signature service module 704a generates a unique electronic finger print for each check imaged by processing solution 400 and stores this unique file for each item in the Check21 Data Warehouse 410 to be utilized along with the MICR code line to test for duplicate checks in duplicate checking module 714.

Next, check image interrogation service 704b captures additional information, such as payor, payee, name and address, water mark, signature or any other field on the check, and performs image interrogation. Such information is stored in the Check21 data warehouse 410 for future search, research, fraud detection, and data mining capabilities.

Next, reconciliation module 712 performs balancing of any group(s) of checks in which the total dollar value captured is not equal to the expected total dollar value. Reconciliation module 712 preferably is the same process in all processing solutions 300, wherein reconciliation module 712 interfaces to legacy and other server systems for both paper and Check21 processing, using the same module. As mentioned earlier, reconciliation module 712 includes “Smart Balancing” with standardized image processing screens throughout all modules.

Next, duplicate checking module 714 performs duplicate check analysis by comparing image files of all Items, because the same check could be presented multiple times in the form of an IRD (paper copy in a check image), the original paper check, X9.37 image file, or an industry electronic file. Duplicate checking module 714 stores the MICR codeline, AX9 704a file, and/or any image interrogation data information from image interrogation module 704b on the C21R 716 Check21 data warehouse database 410. Duplicate checks are flagged and reported by duplicate checking module 514 and removed from the cash letters module 724 (a listing of all items and bundles sent to a destination), posting module 728 (a software application process which extracts all captured data in a electronic file which is in the format to be exported, transmitted and accepted by the accounting, legacy or core business system of the financial institution) and/or power encode module 730 (module running on a document processing machine that encodes the MICR amount on items that are not Check21 items).

Next, IQA/IUA module 718 analyzes the image quality and usability of a check image file. Image files failing the minimum image quality and usability standards are processed by image review module 720, wherein such image file is presented to an operator at workstation 312 and the image is accepted or rejected. Upon rejection, the rejected items will be listed, retrieved and presented to rescan module 722 at workstation 312 for an operator to rescan and re-image the failed image file. Moreover, rescan module 722 includes the ability to rescan “piggy-backed checks.” Piggy-backed checks are checks that stick together as one Item while being fed through a check capture device 301. Rescan module 722 enables image files to be captured and added to the work flow for processes CAR/LAR 704, ICR 706, AE 708, reconciliation 712, duplicate checking 714, C21R 716, IQA 718 and image review 720 modules.

Next, upon completion of reconciliation module 712 and duplicate checking module 714, the check processing work is sorted into “on us” or “transit” work. “On us” work includes image files that belong to the distributed site institution; these proceed to posting module 728 on such institution's core legacy system. The remaining image files and paper checks are outgoing or “transit” items. All such transit items are separated into cash letters which are detailed listings of all items being sent to an endpoint or central site. For paper items (cash letter 724), reports are printed with the listed image files, which may or may not be power encoded module 730 (the process which feeds the items through a check sorter and encodes the amount of the check in the lower right corner of the check in magnetic ink (MICR)). Moreover, image files and data, electronic cash letters, or image cash letters (ICL) 732 (for creating the X9.37 files of cash letters with images), are created in an X9.37 file format for transmission through the transmission gateway in processing solution 300.

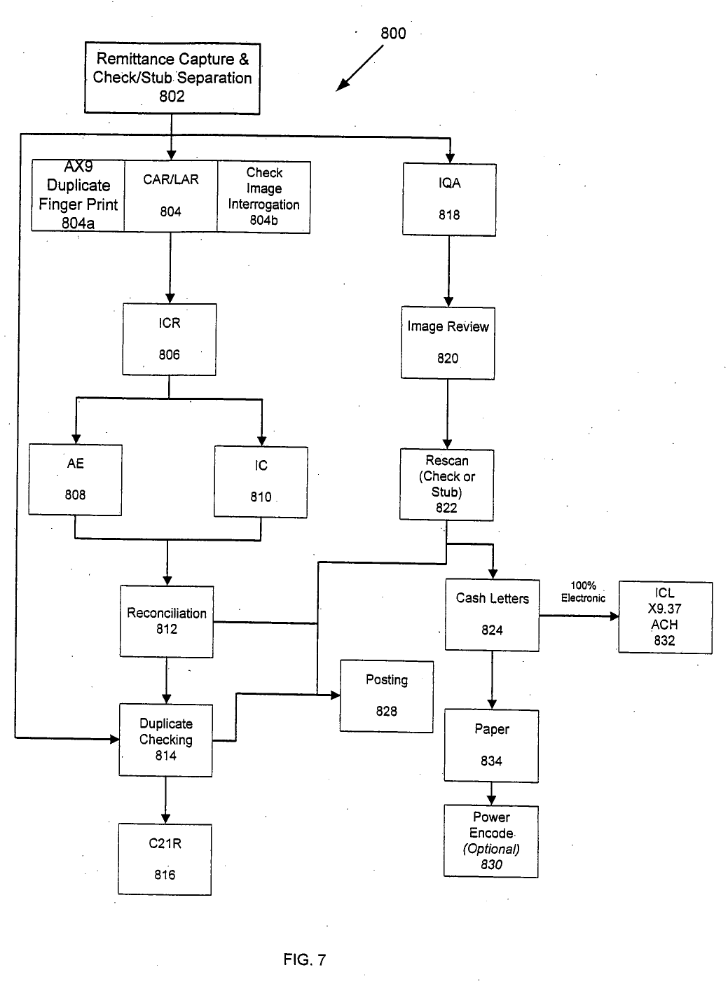

Referring now to FIG. 7, a flow diagram is shown that illustrates a preferred step in a processing solution 400 for remittance capture module process 800. Remittance capture module 700 processes remittance payments with the central capture module 402 workflow and processes. Items processed by the remittance capture module 406 are validated for all processing solution 400 requirements, including IQA, IUA, and duplicated checking, and are send-ready in Check21 X9.37 image files or ACH files formats. Remittance checks are processed electronically and ready for transmission without any paper checks requiring paper cash letter sends. Processing solution 400 is thus capable of processing all remittance checks and/or institutional documents processed electronically without power encoding the amount(s) on the checks or sending out paper cash letters.

In FIG. 7, a flow diagram is shown that illustrates a preferred step in a processing solution 400 for remittance capture module process 800. Remittance capture module 404, of modules 401, of solution 400 controls operation of remittance capture 302 readers/sorters, and controls processing of remittance payments by interfacing and communicating with remittance capture 302 devices. Remittance capture module process 800 begins with capture module 802 which reads, images, endorses (prints a document identification number (DIN) on the back of the check), sorts paper checks to an endpoint pocket, and processes remittance payments on an industry standard check sorter, whether located at the central processing site or attached remotely to the central site. “Module,” as used herein, means a modular set of instructions or protocol to interoperate or communicate with a specific hardware, or to perform a specified process or application. Capture module 802 (application) includes processes for storage of image files of the checks and other control tickets captured, as well as item data captured, including the MICR (magnetic Ink) and any Check21 image quality and/or usability data output by the capture device 301. Process 300 captures the depositor's information in the image proof of deposit (Image POD) and it is later stored in the Check21 data warehouse 410 for returns automation.

Next, process 800 calls CAR/LAR module 804. CAR/LAR electronically reads the dollar amount printed or written in each image file. CAR reads the numeric courtesy amount while the LAR reads the legal amount from the image file. If CAR/LAR module 804 fails to read the check amount, process 800 preferably requires the image file to be processed on an amount entry (AE) 808 workstation 312, wherein an operator reviews the image and keys in the amount of the check.

CAR/LAR module 804 of process 800 controls the capture of remittance stub(s) (the payment document part of a bill sent in with a check for payment of a bill along with the check(s)). The capture sorter device 301 feeds and captures images and data from the stubs and the checks and sends each to appropriate sorter endpoint pockets.

Next, process 800 calls ICR module 806. ICR is a module designed to optically read the E13B magnetic ink font off the image of a check. Additionally, ICR module 806 preferably reads the MICR code line irrespective of whether the check is captured upside down, backwards, or both. Moreover, under an ICR correction routine, ICR module 806 preferably reads Items that are rejected by capture devices 301. Lastly, if ICR module 806 fails to read the Item, process 800 calls item correction module (IC) 810, wherein an operator at work station 312 reviews the image and keys in the correction(s) to the MICR code line in the appropriate boxed fields located directly below each field of the MICR code line of the check displayed on the screen.

Next, AE module 804a generates a unique electronic digital signature for each check imaged by processing solution 400 and stores this unique file for each item in the Check21 data warehouse 410, to be utilized along with the MICR code line to test for duplicate checks in duplicate checking module 814.

Next, check image interrogation module 804b captures additional information, such as payor, payee, name and address, water mark, signature or any other field on the check, and performs image interrogation. Such information is stored in the Check21 data warehouse 410 for future search, research, fraud detection, and data mining capabilities.

Next, reconciliation module 812 performs balancing of any group(s) of checks in which the total dollar value captured is not equal to the expected total dollar value. Reconciliation module 812 preferably is the same process in all processing solution 300, and thus reconciliation module 812 interfaces to legacy and other server systems for both paper and Check21 processing, using the same module. As mentioned earlier, reconciliation module 812 includes “Smart Balancing” with standardized image processing screens throughout all modules.

Next, duplicate checking module 814 performs duplicate check analysis by comparing image files of all Items, because the same check could be presented multiple times in the form of an IRD (paper copy in a check image), the original paper check, X9.37 image file, or an industry electronic file. Duplicate checking module 814 stores the MICR codeline, AX9 804a file, and any image interrogation data information from image interrogation module 804b on the C21R 816 Check21 data warehouse database 410. Duplicate checks are flagged and reported by duplicate checking module 814 and removed from the cash letters module 824 (a listing of all items and bundles sent to a destination), posting module 828 (a software application process which extracts all captured data in a electronic file which is in the format to be exported, transmitted and accepted by the accounting, legacy or core business system of the financial institution) and/or power encode module 830 (module running on a document processing machine that encodes the MICR amount on items that are not Check21 items). Moreover, remittance processing module 406 interfaces with the Check21 data warehouse 3D module 410 during the duplicate checking module 814 process to store the payment account number data from the stub(s) as well as the check MICR codeline data.

Any check returned due to insufficient funds, stopped payment and the like is identified by the remittance capture module 406. The remittance capture module 406 includes an automated returns process which sends a file to posting module 828 to reverse the payment to the posting legacy system.

Next, IQA/IUA module 818 analyzes the image quality and usability of a check image file. Image files failing the minimum image quality and usability standards are processed by image review module 820, wherein such image file is presented to an operator at workstation 312 for further review, and the image is accepted or rejected. Upon rejection, the rejected items will be listed, retrieved and presented to rescan module 822 at workstation 312 for an operator to rescan and re-image the failed image file for a check or payment stub. Moreover, rescan module 822 includes the ability to rescan “piggy-backed checks.” Again piggy-backed checks are checks that stick together as one Item while being fed through a check capture device 301. Rescan module 822 enables image files to be captured and added to the work flow for processes CAR/LAR 804, ICR 806, AE 808, reconciliation 812, duplicate checking 814, C21R 816, IQA 818 and image review 820 modules.

Next, upon completion of reconciliation module 812 and duplicate checking module 814, the check processing work is sorted into “on us” or “transit” work. “On us” work, files that belong to the distributed site institution, proceed to posting module 828 on such institution's core legacy system. The remaining image files and paper checks are outgoing or “transit” items. All such transit items are separated into cash letters, which are detailed listings of all items being sent to an endpoint or central site. For paper items (cash letter 824), reports are printed with the listed image files which may or may not be power encoded by power encoded module 830 (the process which feeds the items through a check sorter and encodes the amount of the check in the lower right corner of the check in magnetic ink (MICR)). Moreover, image files and data, electronic cash letters, or image cash letters (ICL) 832 (for creating the X9.37 files of cash letters with images), are created in an X9.37 file format for transmission through the transmission gateway in processing solution 300.

Next, cash letters module 824 enables all Items to be transmitted electronically. Cash letters module 824 generates Check21 image X9.37 files instead of requiring paper checks to be power encoded and sent out as a paper cash letter. This is a preferred option over sending out cash letters as ACH electronic files, which do not require images, because many Items do not fit the requirements for an ACH send. Moreover, cash letters module 824 enables these items to be processed as Check21 electronic files, as in the check processing central capture module 402.

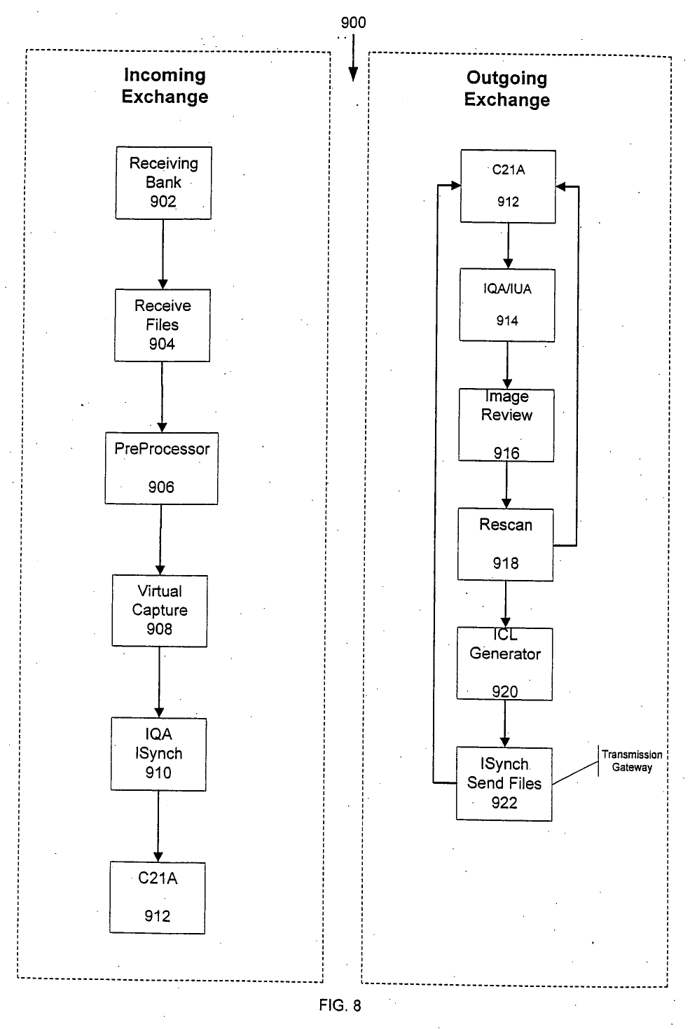

Referring now to FIG. 8, a flow diagram is shown that illustrates a preferred step in a process 400 for image exchange module process 900. Image exchange module process 900 processes both incoming exchange and outgoing exchange. Image exchange 3D module process 900 integrates with the central capture module process 500 and distributed capture module process 600, as well as integrates with industry legacy and server-based check processing and capture systems. Image exchange 3D module process 900 includes a complete suite of reports and search tools.

Incoming exchange is processed by receiving bank module 902, or the financial institution receiving the X9.37 electronic file(s). The X9.37 files are received through the transmission gateway, a component of the receive files module 904 process. Pre-processor module 906 validates the X9.37 incoming files for header and formats according to the Check21 Act standards. Virtual capture module 908 captures the incoming industry standard electronic files (ECP, ECPI, ICL, and X9.37) and performs sort pattern (SPN) verification. At module IQA and ISynch 910, IQA evaluates the image quality for each Item, and ISynch validates the received X9.37 file for completeness to verify every check image corresponds to the data file and that the file is in balance. C21A interfaces with any legacy system and the Image Reject Reentry (AE, IC, and Reconciliation) is processed by the legacy system or in one Capture Module under C21A.

Outgoing exchange can be paper items or images capture files from central capture 402, and/or distributive capture 404, and can further include returned items in electronic files, which are processed to create Check21 files for transmission to the receiving bank (the endpoint to which the items belong). The images and data files of the checks are stored by C21A module 912 database applications. Processing solution 400 preferably can interoperate with any legacy system in which checks are captured, any C21A module 912 that is interfaced, and/or any the sorters and/or distributed scanners. C21A module 912 preferably interfaces with any legacy or server-based check capture system to process Items according to the Check21 Act. IQA/IUA module 914 performs image quality and usability analysis validation. Image files that do not comply with quality and usability standards are sent to image review module 916 for manual Item review. Items that fail manual reviews are sent for processing by rescan module 918. X9.37 image files that do not comply with quality and usability standards are routed to work station 312 for manual review using item review application. Moreover, rescan module 918 supports check industry image scanning/capture devices 301.

Image exchange 3D module process 900 creates “pick lists” by job, block or sorter pocket for the physical location of a paper check to be retrieved and rescanned at a table top check image scanner device/capture device 301. Items are rescanned and the check code line (MICR data printed on the bottom of the check) is matched to the C21A data warehouse 410 database in order to attach the recaptured image to its pre-existing data code line. Rescanned images are stored for easy access, via the creation ICL/X9.37 electronic or X9.37 files by ICL/X9.37 generator module 920. ICL/X9.37 generator module 920 interfaces with the cash letter manager (legacy or Check21A systems) and create electronic files (ECP/ECPI, ICL, ECPD, IRCL or X9.37) from the cash letters. ICL/X9.37 generator module 920 merges in rescanned images captured by the rescan module 918 processes. Image exchange 3D module process 900 includes ISynch module 922a, wherein code line and amount validation are performed to verify a complete and balanced file before released by send files module 922b.

ICL/X9.37 generator module 920 includes output of Check21 IRD files for adhoc or batch printing of image replacement documents (IRD's), which are legal checks reprinted from a Check21 check image file of an Item. ICL/X9.37 generator module 920 generates a complete audit trail and tracking of the IRDs created for the Check21 data warehouse module 410, with duplicate checking as required under Check21 Act.

Image exchange 3D module process 900 includes the transmission gateway process which handles all the transmission and interfaces to and from exchange partners.

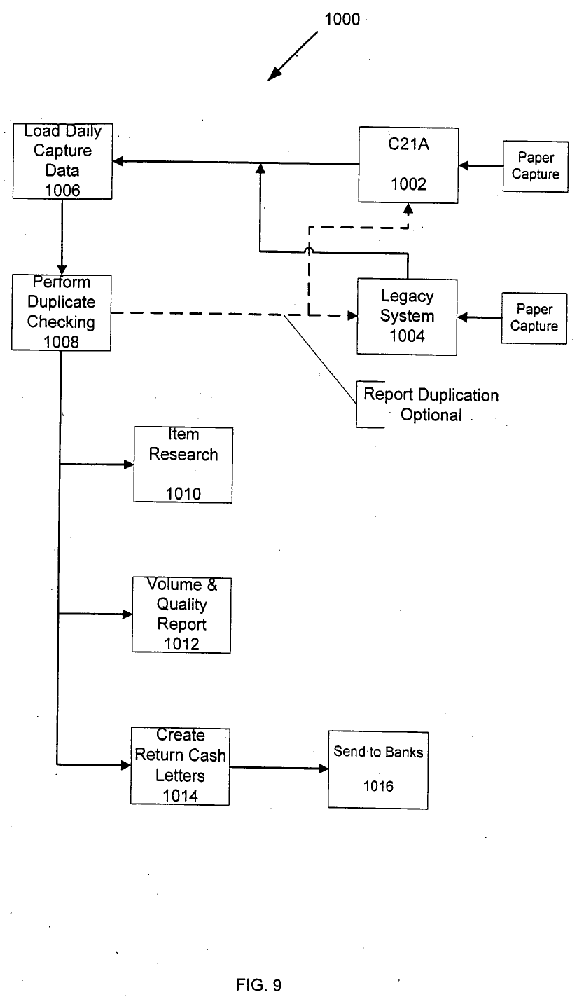

Referring now to FIG. 9, a flow diagram is shown that illustrates a preferred step in a processing solution 400 for Check21 data warehouse module process 1000. Check21 data warehouse module process 1000 integrates with the other modules of processing solution 400, or can standalone to interface with any legacy or server-based financial system subject to Check21 requirements for duplicate checking and archiving of Check21 data. Paper checks are captured by either the legacy system module 1004 and/or C21A module 1002. Check21 data warehouse module process 1000 integrates with third party image archive systems, thereby adding a Check21 data warehouse application, functionality, processes and data mining solutions to such legacy systems. Check21 data warehouse module process 1000 is scalable for any size financial institution and is implemented for duplicate checking and automated returned Items. Check21 data warehouse module process 1000 preferably is configured to provide up to a ten year archival database for the storage of electronic images and data files, as required under Check21 Act 2004, however, such parameters may be defined otherwise using configurator tool under Check21 data warehouse module process 1000.

Each Item captured by central capture module 402 and distributed capture module 404 is stored by load daily capture data module 1006 database server 308. Check21 data warehouse module process 1000 is capable of setting interoperating parameters in system configurator enabling communication with third party storage systems with unique protocols, data formats, and fingerprints for image and data file storage and functionality, such as duplicate checking and other data mining functions. Next, Check21 data warehouse module process 1000 calls perform duplicate checking module 1008 to search image and data files to determine whether or not an Item has been previously processed by processing solution 400. Such determination may be set for designated time periods or within specified dates. Perform duplicate checking module 1008 is a payments data repository application which checks for duplicate sends and receives (checks which are sent or received in the form of paper, X9.37 image files or IRDs).

Next, Check21 data warehouse module process 1000 calls item research module 1010, a PC workstation 312 application with a multitude of standard and custom financial research tools, search query and reporting applications.

Next, Check21 data warehouse module process 1000 calls volume and quality report module 1012 which enables standard reporting, optional duplicate reporting, user generated reporting and IQA and IUA validations reporting of Items. Volume and quality report module 1012 enables data mining functionality, including, for example returns history, method of payment, and multiple check payments, as necessary for automation of returned checks collected during remittance processing module 406 processes.

Next, Check21 data warehouse module process 1000 calls create returns cash letter module 1014, wherein such module automates ACH returns and Check21 X9.37 returns. Create returns cash letter module 1014 performs tracking of the original source of the Item and the original depositor of the Item. Create returns cash letter module 1014 generates reporting for total returns automation. Next, Check21 data warehouse module process 1000 calls send to banks module 1016 to transmit return cash letters to the receiving banks or financial institutions.

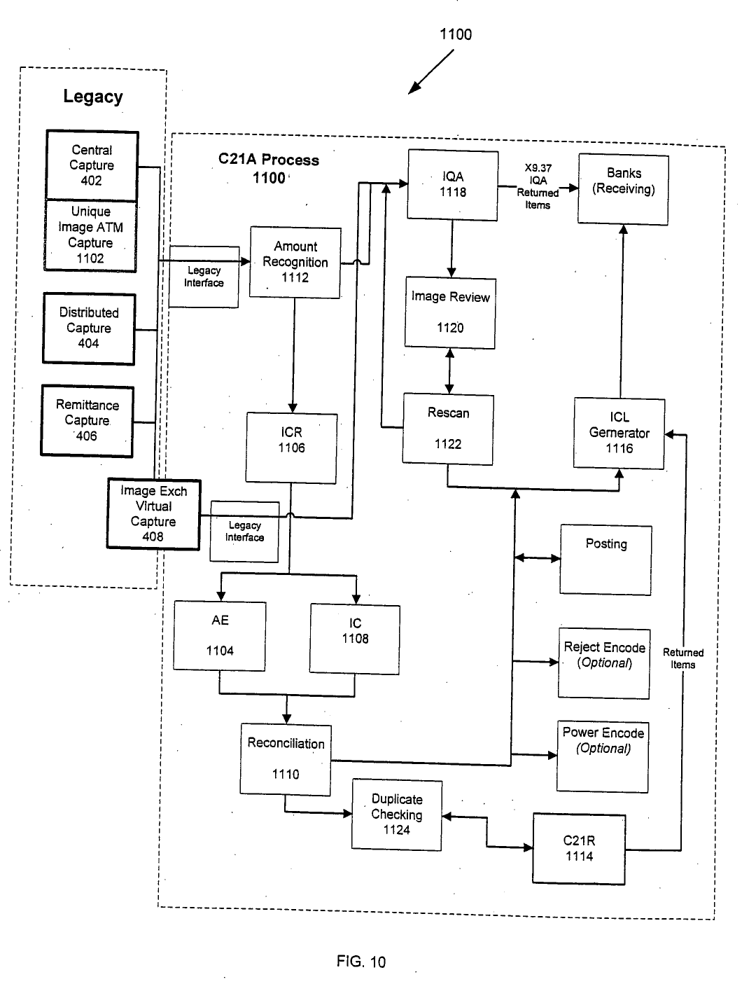

Referring now to FIG. 10, a flow diagram is shown that illustrates a configuration wherein processing solution 400 interoperates with a four element legacy system, core module 1100. As illustrated in FIG. 10, the four modules are interfaced to the core Check21 processing solution 400 in accordance with the invention. Check21 processing solution 400 custom supplied interfaces allow the necessary flows of images and data files to be passed between Check21 processing solution 400 core applications and the legacy systems in their native files. No replacement of components of the legacy system is necessary to add any or all of the functionality of the Check21 processing solution 400 to a currently installed check application or platform. Check21 processing solution 400 can interface and integrate with any legacy system (or server based system to modify and patch it for Check21 compliance). Check21 processing solution 400 incorporates end-to-end Payment Processing, Seamless Design, Capture Anywhere/Process Anywhere, Smart Clients Interface, MICROSOFT .NET Web Server, Remote and Offshore Data Entry, Legacy Systems Interface, and Centralized Configuration and Administration features.

Central Capture 402, Distributed Capture 404, and Remittance Capture 406, Image Exchange 408 (could be partially on the legacy system) and Check21 data warehouse 410 supply all the applications necessary for a complete Check21 system. Check21 processing solution 400 supplies the interfaces as part of the solution 400, or the applications of legacy check processing systems are interfaced by solution 400. The Image ATM Capture module 1102 application is a unique set of processes included in Central Capture module 402, wherein the ATM customer envelope, is captured, and ICR reads the printed transaction data printed by the ATM and compares it to the amount keyed in by the customer at the ATM for validation. Solution 400 completes data entry and reconciliation as necessary.

Check21A process core module 1100 (the right dashed line box in FIG. 10) uniquely interfaces with any legacy or server based check processing system with all or any user functionality required or elected in the invention. Check21A process core module 1100 creates an interface or path to process solution 400 without replacing the current legacy systems and its investment.

### Paper Capture

Central Capture 402, Distributed Capture 404, and Remittance Capture 406 capture paper items on the same systems set forth above and send their images and data files to the Check21A process core module 1100, going to the inventions' third party recognition engines (CAR/LAR, Image Interrogation, or fingerprint (digital signature) generation engines). Failure to read the amount on the check image would require Amount Entry 1104 to be performed. Check MICR data flagged with errors is processed by ICR 1106 and then any failure to automatically correct the read errors requires physical inspection of the check image in Item Correction (IC) 1108 at an IC workstation 312.

Groups of transactions out of balance require Reconciliation 1110 (image review of the item amounts captured). There is a control amount for each group of Items which is compared to the total of all the Items.

Data from all Items processed by the Amount Recognition 1112 is updated in the C21R 1114 Check21 data warehouse 410 database and checked for duplicate items. C21R 1114 functionality exceeds the Check21 requirements for Duplicate Checking and archival storage of IQU/IUA validation. Unique to C21R 1114 is the tracking of items for returns and data mining research facility functionality.

Duplicated checks, and/or checks failing the posting process (Returned Items) are returned to the Bank of First Deposit or depositor in processing solution 400. Included in the Image Cash Letters 1116 is the Returns Cash Letter, Check21 X9.37 file (Cash Letter) and IRD (Image Replacement Document) file that can be printed anywhere.

### Check21 Image Capture

Image Exchange 408 supplied in processing solution 400 incorporates steps shown in the FIG. 10 (the left dashed line box in FIG. 10). The process flow is represented in more detail in FIG. 7, defining preprocessor and virtual capture. Check21 X9.39 files are required to meet standards of image quality and to be represented in balance.

IQA/IUA 1118 image quality and usability analysis validation is performed. Items that fail such analysis or that are questionable will be sent to Image Review 1120 for manual item review in the Item Review Application. Items that fail manual reviews are processed by the Rescan 1122 Manager Application. In the case where the X9.37 file has many image failures or where there is missing data resulting in failures to meet the Check21 standard requirements, the X9.37 file is returned to the source bank. If the source bank is internal to the Image Exchange Virtual Capture 408, these items will require rescan utilizing the internal paper items.

The Image Exchange 408 Rescan Manager process creates “pick lists” by job, block or sorter pocket for the physical location of a paper check to be retrieved and rescanned on a table top check image scanner device 301. This is required because the original image scanned failed to meet industry standards under the Check21 Act of 2004. Items are rescanned and the check code line (MICR data printed on the bottom of the check) is matched to the processing solution 400 database in order to attach the recaptured image to its data code line. Rescanned images are stored for easy access via the creation ICL/X9.37 Generator 1116 of electronic or X9.37 files. Rescan 1122 supports check industry image scanning devices.

The ICL/X9.37 Generator 1116 process is a function within Image Exchange 3D 408. ICL/X9.37 Generator 1116 interfaces with the Cashletter Manager (legacy or C21A) and creates electronic files (ECP/ECPI, ICL, ECPD, IRCL or X9.37) from the cash letters. ICL/X9.37 Generator 1116 merges in rescanned images captured in the Rescan 1122 Manager Process. The invention includes its iSynch process for code line and amount validation, which is performed to verify a complete and balanced file before released as Send Files in Posting 1126.

ICL/X9.37 Generator 1116 includes output of Check21 IRD files for adhoc or batch printing of Image Replacement Documents (IRD's), which are legal checks, reprinted from a Check21 check image files. Processing solution 400 generates a complete audit trail and tracking of the IRDs created for the Check21 data warehouse Module 410 with Duplicate Checking 1124 as required.

Image Exchange 408 includes the Transmission Gateway process which handles all the transmission and interfaces to exchange partners.

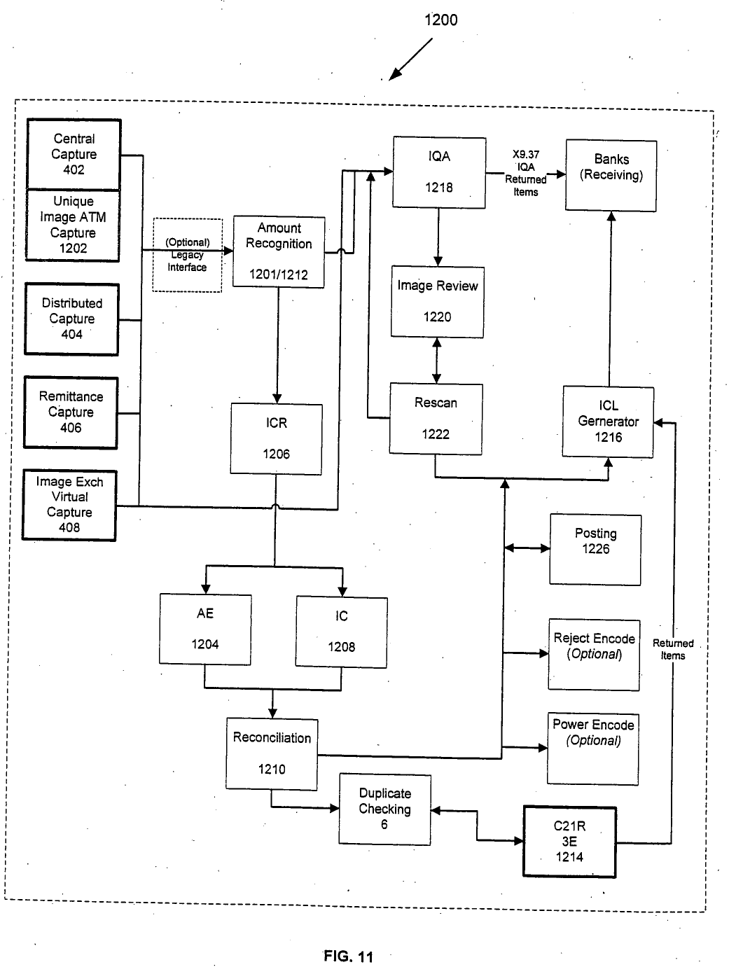

Referring now to FIG. 11, a flow diagram is shown that illustrates a preferred step in a processing solution 400 for Check21 process, core module 1200. As illustrated in FIG. 11, the four modules are now fully integrated into the core Check21 Data Warehouse module process 1200 system in accordance with the invention. FIG. 11 represents the final stage of a new technology, replacing the legacy checking system with a “pure” Check21 Application. All of the functionality of processing solution 400 is installed and available for this demonstrated application or platform. Processing solution 400 provides a “bridge” or path to an integrated system without causing a wholesale replacement of the current system(s). There is no need to build upon the older legacy system (or server based system to modify and patch it for Check21 compliance). The image check sorters and scanners included in the original legacy checking system attach directly to the Central Capture 402 and Distributive Capture 404 Modules supplied in processing solution 400. Processing solution 400 incorporates end-to-end Payment Processing, Seamless Design, Capture Anywhere/Process Anywhere, Smart Clients Interface, MICROSOFT .NET Web Server, Remote and Offshore Data Entry, Legacy Systems Interface, and Centralized Configuration and Administration features.

Central capture 402, distributed capture 404, and remittance capture 406, image exchange 408 and Check21 data warehouse 410 supply all the applications necessary for a complete Check21 System. Check processing solution 400 supplies the interface as part of processing solution 400, or the applications of legacy check processing systems interfaced by processing solution 400. Image ATM Capture 1202 application is a unique set of processes included in central capture 402 which captures the ATM customer envelope. ICR reads the printed transaction data printed by the ATM and compares it to the amount keyed in by the customer at the ATM for validation. Solution 400 completes data entry and reconciliation as necessary.

Check21 process core module 1200 process (gray background area in FIG. 11) uniquely encompasses all or any user functionality required or elected in processing solution 400.

Paper Capture

Central capture 402, distributed capture 404, and remittance capture 406, capture paper items and send the images and data files to Check21 process core module 1200, going to third party recognition engines 1212 (CAR/LAR, image interrogation, or fingerprint generation engines). Failure to read the amount on the check image requires amount entry 1204 to be performed. Check MICR data flagged with errors is processed by ICR 1206 and then any failure to automatically correct the read errors requires physical inspection of the check image in item correction 1208 at an IC workstation 312.

Groups of transactions out of balance require Reconciliation 1210 (image review of the item amounts captured). There is a control amount for each group of Items which is compared to the total of all the Items.

Data from all Items processed by the Amount Recognition 1212 is updated in the C21R 1214 Check21 data warehouse 410 database and checked for duplicate items. C21R 1214 functionality exceeds the Check21 requirements for Duplicate Checking and archival storage of IQU/IUA validation. Unique to C21R 1214 is the tracking of items for returns and data mining research facility functionality.

Duplicated checks and/or checks failing the posting process (Returned Items) are returned to the Bank of First Deposit or depositor in processing solution 400. Included in the Image Cash Letters 1216 is the Returns Cash Letter, Check21 X9.37 file (Cash Letter) and IRD (Image Replacement Document) file that can be printed anywhere.

Check21 Image Capture

Image Exchange 408 supplied in processing solution 400 incorporates steps shown in the gray box in FIG. 11 (the left dashed line box in FIG. 11) for this deployment. The process flow is represented in more detail in Image Exchange FIG. 7, defining Preprocessor and Virtual Capture. Check21 X9.39 files are required to meet standards of image quality and represented in balance.

IQA/IUA 1218 performs image quality and usability analysis validation. Items that fail such analysis, or that are questionable will be sent to Image Review 1220 for manual item review in the Item Review Application. Items that fail manual reviews are processed by the Rescan 1222 Manager Application. In the case where the X9.37 file has many image failures or where there is missing data, such that it fails to meet the Check21 standard requirements, the X9.37 file is returned to the source bank. If the source bank is internal to the image exchange virtual capture 408, these items will require rescan utilizing internal paper items.

The image exchange 3D 408 rescan manager process creates “pick lists” by job, block or sorter pocket for the physical location of a paper check to be retrieved and rescanned on a table top check image scanner device 301. This is required since the original image scanned of this Item failed to meet industry standards under the Check21 Act of 2004. Items are rescanned and the check code line (MICR data printed on the bottom of the check) is matched to the processing solution 400 database in order to attach the recaptured image to its data code line. Rescanned images are stored for easy access and the creation ICL/X9.37 Generator 1216 of electronic or X9.37 files. Rescan 1222 supports check industry image scanning devices.

The ICL/X9.37 generator 1216 process is a function within Image Exchange 3D 408. ICL/X9.37 generator 1216 interfaces with the Cashletter Manager (legacy or C21A), and creates electronic files (ECP/ECPI, ICL, ECPD, IRCL or X9.37) from the cash letters. X9.37 generator 1216 merges in rescanned images captured in the Rescan 1222 Manager Process. The invention includes its iSynch process for code line and amount validation, which is performed to verify a complete and balanced file before released as Send files in posting 1226.

X9.37 generator 1216 includes output of Check21 IRD files for adhoc or batch printing of Image Replacement Documents (IRD's), which are legal checks, reprinted from a Check21 check image files. Processing solution 400 generates a complete audit trail and tracking of the IRDs created for the Check21 data warehouse module 410 with Duplicate Checking as required.

Image exchange 408 includes the Transmission Gateway process which handles all the transmission and interfaces to exchange partners.

Process 400 incorporates end-to-end payment processing, seamless design, capture anywhere/process anywhere, smart clients interface, MICROSOFT .NET web server, remote and offshore data entry, legacy systems interface, and centralized configuration and administration features. Moreover, these modules and processes are identical across all modules and applications of process 400 whether processed remotely or in the central site. Each module, component and process is parameter based using the System Configuration and the System Administration to customize processing solution 400 or activate or deactivate any module within processing solution 400 to enable interoperability with any existing or legacy financial system.

Although the description given above includes specific examples of currently envisioned embodiments of the computer program, method, system, and/or apparatus, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. It is to be understood that this exemplary system is merely illustrative, and should not be considered as in any way limiting the scope of the invention, since the invention is applicable to other types of document processing systems, financial and otherwise. Accordingly, the claims that follow herein and their legal equivalents, rather than the examples given in the specification, should determine the scope of present.

What is claimed is:

1. A negotiable instrument image processing system comprising:
one or more image capture devices for capturing and transmitting electronic image file and data from the negotiable instrument;
at least one image file server for temporary storage and transmission of said image and data;
at least one database server for storage of said image and data;
a central processing system for exchanging, analyzing, verifying and storing said image and data;
at least one workstation for configuring, administering and managing said processing system;
at least one web server for communicating control information between said workstation and said database server;
at least one communication network for the transmitting said image, data and control information between said devices, servers and workstations; and
one or more software modules running on a .NET platform for supporting said devices, servers, and workstations.

2. The system of claim 1, wherein said negotiable instrument processing further comprises means for controlling, capturing, reviewing, transmitting, storing, and processing of said image and data.

3. The system of claim 1, wherein said image capture device further comprises means for reviewing and entering data missing in the second image from the negotiable instrument.

4. The system of claim 1, wherein said image capture device further comprises a prime capture device for centralized capture, review and transmission of said image and data.

5. The system of claim 4, wherein said image capture device further comprises a prime capture device for remote capture, review and transmission of batch said images and data.

6. The system of claim 1, wherein said image capture device further comprises a distributed capture device for remote capture, review and transmission of said image and data.

7. The system of claim 1, wherein said image capture device further comprises a distributed capture device for remote capture, review and transmission of batch said images and data.

8. The system of claim 1, wherein said software module further comprises instructions and interface drivers for controlling and communicating with said image capture devices.

9. The system of claim 1, wherein said software module further comprises instructions, services and interface drivers for controlling and communicating with said servers.

10. The system of claim 1, further comprising a workstation for data entry, reconciliation, review, search and rescan of said image and data.

11. The system of claim 1, wherein said software module further comprises instructions, services and interface drivers for controlling and communicating with said workstation.

12. The system of claim 1, further comprising a communication link to the Internet.

13. The system of claim 1, wherein said software modules comprise independent code sections for performing specific functions.

14. The system of claim 1, wherein said software modules comprise independent code sections for supporting said one or more image capture devices.

15. The system of claim 1, wherein said software modules comprise independent code sections for supporting said at least one image file and web servers.

16. The system of claim 1, wherein said software modules comprise independent code sections for supporting said at least one workstation.

17. The system of claim 1, wherein said one or more software modules comprise independent code sections for enabling communication between said devices, servers and workstations.

18. The system of claim 1, wherein said software modules further comprise means for enabling interoperability between said negotiable instrument image processing system and a legacy hardware and software system.

19. The system of claim 1, wherein said software modules further comprise means for removal of support for said one or more image capture devices.

20. The system of claim 1, wherein said software modules further comprise means for adding support for said devices.

21. The system of claim 1, wherein said software modules further comprises means for removing negotiable instrument imaging and processing applications.

22. The system of claim 1, wherein said software modules further comprises means for adding negotiable instrument imaging and processing applications.

23. The system of claim 1, wherein said software modules further comprises means for reviewing said negotiable instrument image and entering missing information from said negotiable instrument image.

24. The system of claim 6, wherein said software modules enable an operator of said distributed capture to review said image and enter missing data from said image.

25. The system of claim 5, wherein said software modules enable an operator of said prime capture to review said image and enter missing data from said image.

26. The system of claim 1, wherein said software modules enable an operator of said workstation to review said image and enter missing data from said image.

27. The system of claim 1, wherein said processing system further comprises means for data entry.

28. The system of claim 1, wherein said processing system further comprises means for image capture.

29. The system of claim 1, wherein said processing system further comprises means for reconciliation.

30. The system of claim 1, wherein said processing system further comprises means for reviewing said image file and data for accuracy.

31. The system of claim 1, wherein said processing system further comprises means for rescanning the negotiable instrument.

32. The system of claim 1, wherein said processing system further comprises means for distributed capture of said image of the negotiable instrument.

33. The system of claim 1, wherein said processing system further comprises means for prime capture of said image of the negotiable instrument.

34. The system of claim 1, wherein said processing system further comprises means for image exchange.

35. The system of claim 1, wherein said processing system further comprises means for incoming exchange.

36. The system of claim 1, wherein said processing system further comprises means for outgoing exchange.

37. The system of claim 1, wherein said processing system further comprises means for data warehouse.

38. The system of claim 1, wherein said processing system further comprises means for central capture.

39. The system of claim 1, wherein said processing system further comprises means for distributed capture.

40. The system of claim 1, wherein said processing system further comprises means for data remittance processing.

41. A method of processing negotiable instruments, said method comprising the steps of:
obtaining a check21 image based processing system comprising one or more image capture devices, at least one image file server, at least one database server, at least one workstation, at least one communication network, one or more software modules running on a .NET platform;
capturing image file and data information from the negotiable instrument;
exchanging said image and data within and between a plurality of devices, servers, and workstations in said negotiable instrument processing system;
storing said image and data in said database;
executing said software modules for supporting said devices, servers, and workstations; and
performing negotiable instrument processing applications.

42. The method of claim 41, wherein said capturing image and data file information is performed remotely from the location of said central processing system.

43. The method of claim 41, wherein said capturing image and data file information is performed by said central processing system.

44. The method of claim 41, wherein said software modules comprise independent code sections for performing specific functions.

45. The method of claim 41, wherein said software modules comprise subroutines for supporting specific hardware devices.

46. The method of claim 41, wherein said software modules enable interoperability with legacy hardware and software systems.

47. The method of claim 41, wherein said software modules facilitate the removal or addition of support for said devices.

48. The method of claim 41, wherein said software modules facilitate the removal or addition of negotiable instrument imaging and processing applications.

49. The method of claim 41, wherein said processing comprises data entry.

50. The method of claim 41, wherein said processing comprises reconciliation.

51. The method of claim 41, wherein said processing comprises review of said data.

52. The method of claim 41, wherein said processing comprises search capabilities.

53. The method of claim 41, wherein said processing comprises rescan capabilities.

54. The method of claim 41, wherein said software modules facilitate the addition of negotiable instrument imaging and processing applications.

55. The method of claim 41, wherein said software modules facilitate the removal of negotiable instrument imaging and processing applications.

56. The method of claim 41, wherein said software modules enable an operator to enter missing data from said image file.

57. A method of adapting a legacy negotiable instruments processing system, said method comprising the steps of:
obtaining a check21 image based processing system comprising one or more image capture devices, at least one image file server, at least one database server, at least one workstation, at least one communication network, one or more software modules running on a .NET platform;
selecting any one or more software modules from the group consisting of a central capture, a distributed capture, a remittance processing, an image exchange, an incoming exchange, an outgoing exchange, a data warehouse;
capturing image file and data information from the negotiable instrument;
exchanging said image and data within and between a plurality of devices, servers, and workstations in said negotiable instrument processing system;
storing said image and data in said database;
executing software modules for supporting said devices, servers, and workstations; and
performing negotiable instrument processing applications.

58. The method of claim 57, wherein said capturing image and data file information is performed remotely from the location of said central processing system.

59. The method of claim 57, wherein said capturing image and data file information is performed by said central processing system.

60. The method of claim 57, wherein said software modules comprise independent code sections for performing specific functions.

61. The method of claim 57, wherein said software modules comprise subroutines for supporting specific hardware devices.

62. The method of claim 57, wherein said software modules enable interoperability with legacy hardware and software systems.

63. The method of claim 57, wherein said software modules facilitate the removal or addition of support for said devices.

64. The method of claim 57, wherein said software modules facilitate the removal or addition of negotiable instrument imaging and processing applications.

65. The method of claim 57, wherein said processing comprises data entry.

66. The method of claim 57, wherein said processing comprises reconciliation.

67. The method of claim 57, wherein said processing comprises review of said data.

68. The method of claim 57, wherein said processing comprises search capabilities.

69. The method of claim 57, wherein said processing comprises rescan capabilities.

70. The method of claim 57, wherein said software modules facilitate the addition of negotiable instrument imaging and processing applications.

71. The method of claim 57, wherein said software modules facilitate the removal of negotiable instrument imaging and processing applications.

72. The method of claim 57, wherein said software modules enable an operator to enter missing data from said image file.
